(19) United States
(12) Patent Application Publication
(10) Pub. No.: US 2011/0134231 A1
(43) Pub. Date: Jun. 9, 2011

(54) Method And System For Synchronizing Shutter Glasses To A Display Device Refresh Rate

(76) Inventors: Robert W. Hulvey, Redondo Beach, CA (US); Shawn Shiliang Ding, San Diego, CA (US)

(21) Appl. No.: 13/028,907

(22) Filed: Feb. 16, 2011

Related U.S. Application Data
(63) Continuation-in-part of application No. 12/943,741, filed on Nov. 10, 2010.
(60) Provisional application No. 61/281,893, filed on Nov. 20, 2009.
(60) Provisional application No. 61/313,489, filed on Mar. 12, 2010.

(51) Int. Cl. H04N 13/04

(52) U.S. Cl. 348/56; 348/E13.059

(57) ABSTRACT

A video viewing shutter device, which is wirelessly coupled to a multi-view video display device, generates a slave clock based on a master clock in the display device. The slave and master clocks may be Bluetooth clocks and maintain synchronization. The video viewing shutter device receives display information regarding display of independent video frames and time information referenced to the master clock. Time information corresponds to display time of independent frames. Both shutters open and/or close together, during frame display time, based on the slave clock, display information and/or master clock information. Display information may concern a pattern of independent frames and/or blank frames, pattern display time, refresh rate and/or a time offset. Master clock time information corresponds to frame display time. Shutter open and close times may be maintained when display and/or time information is not received. Information may be transmitted to the multi-view video display device.

### CROSS-REFERENCE TO RELATED APPLICATIONS/INCORPORATION BY REFERENCE

This application claims priority to and is a continuation in part of, U.S. application Ser. No. 12/943,741, filed on Nov. 10, 2010.

This application makes reference to, claims priority to, and claims the benefit of U.S. Provisional Application Ser. No. 61/281,893, filed on Nov. 20, 2009.

This application also makes reference to, claims priority to, and claims the benefit of U.S. Provisional Application Ser. No. 61/313,489, filed on Mar. 12, 2010, which is incorporated herein by reference in its entirety.

Each of the above stated applications is hereby incorporated herein by reference in its entirety.

### FIELD OF THE INVENTION

Certain embodiments of the invention relate to communication systems. More specifically, certain embodiments of the invention relate to synchronizing shutter glasses to a display device refresh rate.

### BACKGROUND OF THE INVENTION

Video content may be recorded in two-dimensional (2D) format or in three-dimensional (3D) format. In various applications such as, for example, DVD movies and TV, a 3D video is often desirable because it is often more realistic to viewers than the 2D counterpart. A 3D video comprises left view frames and right view frames. 3D glasses may be utilized for viewing 3D video content. Exemplary 3D glasses may utilize polarizing technology or shutter techniques, for example.

In order to produce images which can be viewed by consumers with a 3-dimensional (3D) effect, videos are often filmed and rendered stereoscopically. For example, to produce video, a stream of images may be produced for viewing with the right eye and another stream of images may be produced for viewing with the left eye. The images are typically taken such that one of the image streams is taken from a perspective which is slightly offset from the other, in the same way that the perspective seen by the right eye is slightly offset from that seen by the left eye.

Various display systems for 3D video, such as televisions and film or video projectors, display a stream of images in sequence at a rate known as the refresh rate. One popular system for reproducing these 3D videos involves displaying images at twice the normal refresh rate of non-3D video, alternating images for the left and right eyes. A viewer may wear glasses which contain LC shutters, for example, that are electronically controlled such that the left eye shutter is open when an image for the left eye is being displayed, and the right eye shutter is open when an image for the right eye is being displayed.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for synchronizing shutter glasses to a display device refresh rate.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram that illustrates an exemplary sequence of left and right 3D video frames, in accordance with an embodiment of the invention.

FIG. 1B is diagram that illustrates an exemplary sequence of left, right and blank 3D video frames, in accordance with an embodiment of the invention.

FIG. 2 is a diagram that illustrates exemplary synchronization of left and right shutters in a 3D viewing device with left view and right view 3D frames that are displayed on a 3D video display device, in accordance with an embodiment of the invention.

FIG. 3 is a diagram that illustrates an exemplary wireless communication link between a 3D viewing shutter device and a 3D video display device, in accordance with an embodiment of the invention.

FIG. 4 is block diagrams that illustrates an exemplary 3D viewing shutter device that is operable to determine when to open and close left and right shutters based on clock and 3D frame refresh information received from a 3D video display device via a wireless link, in accordance with embodiments of the invention.

FIG. 5 is a diagram that illustrates a plurality of exemplary 3D shutter glasses and other wireless devices communicating with a 3D video display device via Bluetooth wireless connections, in accordance with an embodiment of the invention.

FIG. 6 is a flow chart illustrating exemplary steps for synchronizing 3D shutter glasses to a television 3D frame refresh rate, in accordance with an embodiment of the invention.

FIG. 7A is a diagram that illustrates two different and/or independent frame sequences that may comprise different and/or independent content, in accordance with an embodiment of the invention.

FIG. 7B is a diagram that illustrates an exemplary sequence of frames that comprises frames alternating from a plurality of different and/or independent frame sequences, in accordance with an embodiment of the invention.

FIG. 7C is diagram that illustrates an exemplary sequence of frames that may comprise frames from a plurality of different and/or independent frame sequences and blank frames, in accordance with an embodiment of the invention.

FIGS. 8a and 8B are diagrams that illustrate exemplary synchronization among a plurality of shutter viewing devices at time instants T1 and T2, in accordance with an embodiment of the invention.

FIG. 9 is a diagram that illustrates exemplary viewing shutter devices that are operable to determine when to open and close shutters based on information received from a video display device via a wireless link, in accordance with an embodiment of the invention.

FIG. 10 is a flow chart illustrating exemplary steps for synchronizing each one of a plurality of shutter devices to display of a corresponding one of plurality of interleaved frame sequences, in accordance with an embodiment of the invention.

### DETAILED DESCRIPTION OF THE INVENTION

Certain embodiments of the invention can be found in a method and system for synchronizing shutter glasses to a display device refresh rate. In various embodiments of the invention, in a video viewing shutter device that is wirelessly coupled to a multi-view video display device, a slave clock may be generated based on a master clock in the multi-view video display device. Synchronization of the slave clock with the master clock may be maintained. The video viewing shutter device may receive information about display of one or more of a plurality of different and/or independent video frames and time information that is referenced to the master clock, from the multi-view video display device. The time information may correspond to a time of the display of the one or more of the plurality of different and/or independent video frames. Both shutters of the video viewing shutter device may be opened and/or closed to correspond to a time of display of one of the plurality of different and/or independent video frames. Furthermore, both shutters may be opened and/or closed based on the generated slave clock, the received information about the display of the one or more of the plurality of different and/or independent video frames, and/or the received time information that is referenced to the master clock. The slave clock and the master clock may comprise a Bluetooth slave clock and a Bluetooth master clock respectively. The information about the display of the one or more of the plurality of different and/or independent video frames, may comprise information about a pattern of frames. The pattern of frames may comprise one or both of frames from the plurality of different and/or independent frame sequences and blank frames, which are displayed on the multi-view video display device. The information about the display of the one or more of the plurality of different and/or independent video frames may comprise a length of a time interval corresponding to displaying a pattern of frames which comprises one or both of frames from the plurality of different and/or independent frame sequences and blank frames that are displayed on the multi-view video display device. The information about the display of the one or more of the plurality of different and/or independent video frames may comprise a refresh rate for displaying frames from at least one of the plurality of different and/or independent frames sequences. The time information that is referenced to the master clock may indicate master clock time that may correspond to the display of the one or more of the plurality of different and/or independent video frames.

The information about the display of the one or more of the plurality of different and/or independent video frames may comprise a time offset for delaying opening and/or closing of both shutters of the video viewing shutter device. Both shutters may be opened and/or closed based on the generated slave clock, the received information about the display of the one or more of the plurality of different and/or independent video frames and the received time information that is referenced to the master clock. A correspondence in time between a time of opening and closing both shutters and the time of the display of the one or more of the plurality of different and/or independent video frames may be maintained when new information about display of the one or more of the plurality of different and/or independent video frames and new time information that is referenced to the master clock, is not received and/or not utilized. Information may be transmitted to the multi-view video display device. For example, information comprising timing, configuration, security and/or capabilities information may be transmitted by the video viewing shutter device to the multi-view video display device. In this manner, a shutter device may be synchronized to a television refresh rate.

Certain embodiments of the invention can be found in a method and system for synchronizing 3D shutter glasses to a television refresh rate. In accordance with various embodiments of the invention, a 3D video viewing shutter device that is communicatively coupled, wirelessly, to a 3D video display device may generate a slave clock based on a master clock in the 3D video display device. The 3D video viewing shutter device may maintain synchronization with the master clock. The 3D video viewing shutter device may receive from the 3D video display device, information about display of 3D video frames and time information that is referenced to the master clock. The time information may correspond to a time of the display of the 3D video frames. The 3D video viewing shutter device may determine when to open and close left and right shutters to correspond to the time of the display of the 3D video frames. The determination may be based on the generated slave clock, the received information about the display of the 3D video frames and/or the received time information that is referenced to the master clock. The slave clock and the master clock may comprise a Bluetooth slave clock and a Bluetooth master clock respectively. The information about the display of 3D video frames may comprise information about a pattern of left, right and/or blank frames that are displayed on the 3D video display device. Furthermore, the information about the display of 3D video frames may comprise length of a time interval that corresponds to display of a pattern of left, right and/or blank frames that are displayed on the 3D video display device. The invention may further enable viewing of independent video streams by two or more individuals.

The information about the display of 3D video frames may comprise a refresh rate for displaying left, right and/or blank frames that are displayed on the 3D video display device. The time information that is referenced to the master clock may indicate master clock time that corresponds to the display of 3D video frames. The information about the display of 3D video frames may comprise a time offset for delaying opening and/or closing of left and right shutters. Opening and closing of the left and right shutters may be based on the generated slave clock, the received information about the display of 3D video frames and the received time information that is referenced to the master clock. A correspondence in time between time of the opening and closing of the left and right shutters and the time of the display of the 3D video frames may be maintained even when new information about the display of 3D video frames, and new time information that is referenced to the master clock, is not received and/or not utilized. In various embodiments of the invention, information comprising, for example, timing, configuration, security and/or capabilities information may be transmitted by the 3D video viewing shutter device to the 3D video display device. In this manner, 3D shutter glasses may be synchronized and operated in time with display of a 3D video utilizing a Bluetooth wireless interface between the 3D shutter glasses and a 3D video display device.

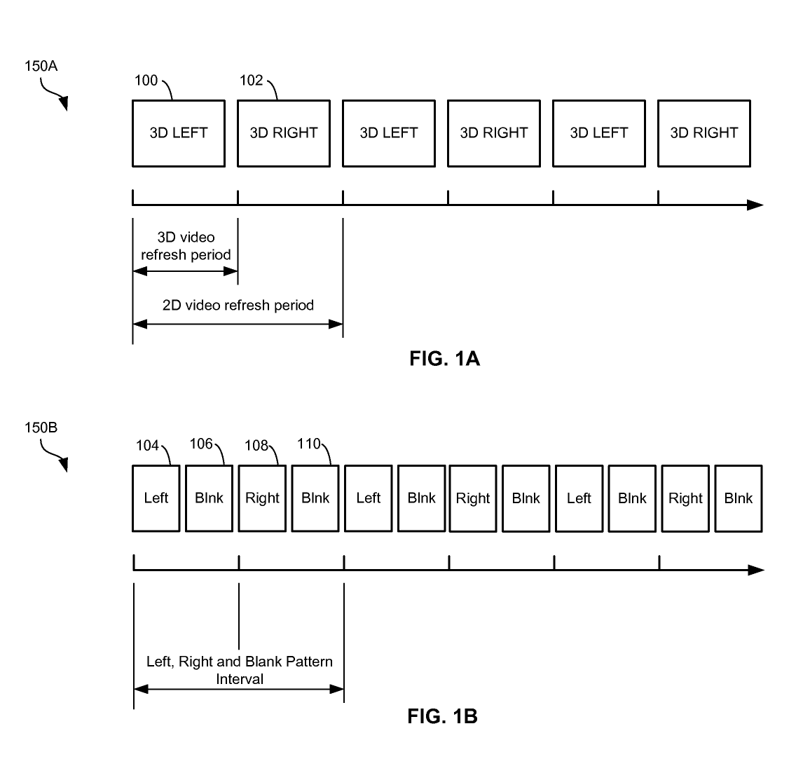

FIG. 1A is a diagram that illustrates an exemplary sequence of left and right 3D video frames, in accordance with an embodiment of the invention. Referring to FIG. 1A, there is shown a sequence of left view and right view 3D video frames 150A that comprises a left view frame 100 and a right view frame 102.

The sequence of left view and right view 3D video frames 150A may comprise stereoscopic video and/or graphics images. The left view frame 100 and the right view frame 102 may comprise images of the same subject matter that are seen from slightly different angles and when viewed sequentially, may create an illusion of a three dimensional image. Left view frames and right view frames may be referred to as left frames and right frames. Alternatively, the sequence of frames 150A may comprise alternating images from different video sequences that may be viewed concurrently by different people. The different video sequences may comprise different and/or independent content instead of left and right views. For example, the frame 100 may comprise an image from a first video sequence and the frame 102 may comprise an image from a second video sequence. Two people may view the two sequences concurrently, for example, utilizing shutter glasses. In this regard, one person may view the first sequence with shutter glasses for which both lenses are open during display of frames from the first sequence and closed during display of frames from the second sequence while another person may view the second sequence with shutter glasses for which both lenses are open during display of frames from the second sequence and closed during display of frames from the first sequence. The frames from the first sequence may be considered analogous to the left view 3D frames and the frames from the second sequence may be considered analogous to the right view 3D frames, for example. In some instances, the frames from the first sequence may be referred to as left view 3D frames and the frames from the second sequence may be referred to as the right view 3D frames. In this manner, various embodiments of the invention may enable viewing of independent video streams by two or more individuals rather than viewing of left and right 3D video streams.

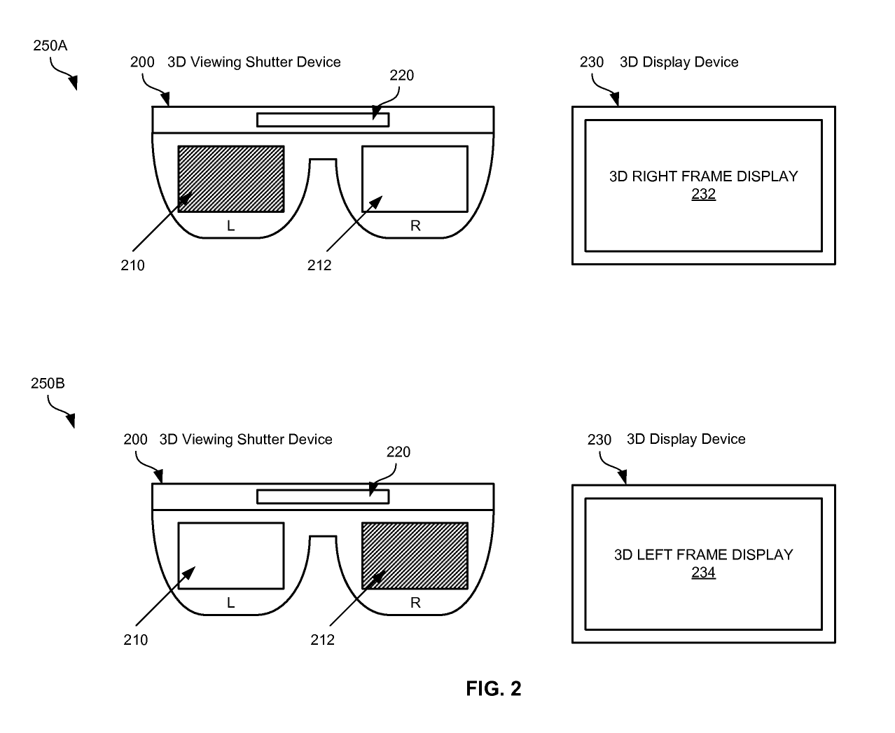

In operation, the sequence of left view and right view 3D video frames 150A may be displayed on a 3D video display device (shown in FIG. 2). The left view frame 100 is generated for viewing with a left eye and the right view frame 102 is generated for viewing with a right eye. When 3D videos are displayed in this manner, a viewer may utilize a 3D viewing device, for example 3D glasses (shown in FIG. 2). The 3D glasses may utilize a shuttering technique that may block vision in one eye while enabling vision in the other eye. This may be referred to as opening a shutter or closing a shutter. A viewing device that utilizes a shuttering technique may be referred to as 3D shutter glasses. Shuttering may be electronically controlled such that the left eye shutter is open only when an image for the left eye is being displayed on a display device, and the right eye shutter is open only when an image for the right eye is being displayed on the display device. When a shutter is closed, the image being displayed on the display is substantially blocked by the shutter. In various embodiments of the invention, the shutters are made using liquid crystal (LC) elements and such shutters are typically referred to as LC shutters.

FIG. 1B is diagram that illustrates an exemplary sequence of left, right and blank 3D video frames, in accordance with an embodiment of the invention. Referring to FIG. 1B, there is shown a sequence comprising left view, right view and blank 3D video frames 150B that comprises a left view frame 104, a blank frame 106, a right view frame 108 and a blank frame 110.

The sequence comprising left view, right view and blank 3D video frames 150B may comprise stereoscopic video and/or graphics images as well as blank or black frames. The blank or black frames 106 and 110 may be utilized to reduce crosstalk between left and right frames. For example, left and right 3D video frames may be displayed on a persistent display, such as a liquid crystal display (LCD). One frame of image data may be written to the display and corresponding pixels may be illuminated with the written content until another value is written over the first frame data. In instances when a screen may be partially illuminated with a left view frame and partially illuminated with a right view frame, a viewer may perceive crosstalk. One or more blank frames may be inserted between left and right frames, for example, in a pattern comprising left, right and blank frames, to compensate for display screen response time. A time offset for opening and closing of shutters may be utilized in shutter glasses to allow for the response time of a persistent display.

Similar to the sequence of frames 150A, the sequence of frames 150B may comprise alternating images from different video sequences that may be viewed concurrently by different people. For example, the frame 104 may correspond to one video sequence and the frame 108 may correspond to another video sequence. The frames corresponding to one video sequence may be considered analogous to the left view 3D frames and the frames corresponding to the other video sequence may be considered analogous to the right view 3D frames, for example. In some instances, the frames corresponding to one video sequence may be referred to as left view 3D frames and the frames corresponding to the second sequence may be referred to as the right view 3D frames.

FIG. 2 is a diagram that illustrates exemplary synchronization of left and right shutters in a 3D viewing device with left view and right view 3D frames that are displayed on a 3D video display device, in accordance with an embodiment of the invention. Referring to FIG. 2, there is shown a time instant 250A and a time instant 250B. In addition, there is shown a 3D viewing shutter device 200 that may comprise a left shutter 210 and a right shutter 212, and a shutter controller 220. Also shown is a 3D video display device 230, a displayed 3D right frame 232 and a displayed 3D left frame 234. The 3D viewing shutter device 200 and 3D video display device 230 are shown at time instant 250A and again at time instant 250B.

The 3D video display device 230 may comprise suitable logic, circuitry, interfaces and/or code that may be operable to display time sequential 3D video frames which may comprise left view frames, right view frames and/or blank frames such as, for example, the sequence of left view and right view 3D video frames 150A and the sequence comprising left view, right view and blank 3D video frames 150B. The left view frames, right view frames and/or blank frames may be referred to as left, right and/or blank frames. The invention is not limited to any specific type of 3D display device and may utilize any suitable 3D display device, for example, a liquid crystal display (LCD), a rear projector display or a plasma display may be utilized. Exemplary embodiments of the 3D video display device 230 may comprise a television, a computer monitor, a gaming device, a navigation device and/or a video projector, however, the invention is not limited in this regard. A viewer may utilize the 3D viewing shutter device 200 to perceive an illusion of 3D images in the 3D left view and right view frames. The 3D video display device 230 may be operable to communicate with the 3D viewing shutter device 200 to synchronize left and right shutters 210 and 212 with the display of left and right 3D frames 234 and 232. The 3D viewing shutter device 200 may comprise 3D shutter glasses and may be referred to as the 3D shutter glasses 200, for example. In addition, the 3D viewing shutter device 200 may be referred to as the 3D video viewing shutter device.

In various embodiments of the invention, the 3D video display device 230 and the 3D viewing shutter device 200 may be operable to communicate via a Bluetooth connection. Communication between the two devices may be synchronized with master and slave clocks. For example, the 3D viewing shutter device 200 may comprise a slave clock which is kept synchronized to a master clock comprised by the 3D video display device 230. The master and/or slave clocks may comprise master and slave Bluetooth clocks; however, the invention is not limited with regard to the type or source of a clock signal and may utilize any suitable clock mechanism.

In accordance with the Bluetooth wireless standard, for any connection between two Bluetooth-enabled devices, one device may take on the role of master device while the other may take on the role of slave device. At any instant in time, there may be multiple slave devices and a single master device. The master device may maintain a free-running counter, typically referred to as a Bluetooth clock. The slave device may maintain a copy of this counter, which the slave device phase-locks to the Bluetooth clock on the master device to within a few microseconds, for example. The phase of the slave clock may, in some embodiments, be updated when the slave device receives a packet from the master device. The Bluetooth clock may therefore provide a time reference that may be utilized to synchronize processes on both sides of the Bluetooth link. In this manner, a Bluetooth clock may be utilized to synchronize right and left shutters 212 and 210 in the 3D viewing shutter device 200 with the displayed 3D right frame 232 and the displayed 3D left frame 234 on the 3D video display device 230.

The 3D video display device 230 may comprise suitable logic, circuitry, interfaces and/or code that may be operable to determine when a left, right and/or blank 3D frames are being displayed and may be operable to generate a signal that indicates when 3D left frames, right frames and/or blank frames are displayed. The generated signal may be referred to as a frame synchronization signal. For example, a square wave may be generated that may measure as positive when a left frame is displayed and may measure as negative when a right frame is displayed. Notwithstanding, the invention is not limited in this regard, and any suitable frame synchronization signal or indicator of left, right and/or blank frame generation may be utilized. The 3D video display device 230 may record a time that is associated with a certain event in the frame synchronization signal or associated with a certain event that occurs when displaying left view, right view and/or blank 3D frames. For example, the 3D video display device 230 may record a time instant when a positive rising edge of a generated signal may indicate that a left view 3D frame is being refreshed on the 3D video display device 230. The 3D video display device 230 may communicate the recorded time instant to the 3D viewing shutter device 200.

The 3D viewing shutter device 200 may comprise suitable logic, circuitry, interfaces and/or code that may be operable to synchronize opening and closing of left and right shutters with a 3D frame refresh rate of a display screen, for example, of the 3D video display device 230. The 3D viewing shutter device 200 may be utilized when viewing 3D video and/or graphics frames on the 3D video display device 230 to create an illusion of viewing a three dimensional image. The 3D viewing shutter device 200 may comprise 3D shutter glasses and may be referred to as the 3D shutter glasses 200, however, the invention is not limited in this regard and any suitable form factor for the 3D viewing shutter device 200 may be utilized. In addition to glasses, exemplary form factors for the 3D viewing shutter device 200 may comprise goggles, a hat, a visor, a helmet, binoculars and/or a handheld device. In an exemplary pair of 3D shutter glasses 200, the shutter 210 that may correspond to a left eye may block light from reaching the left eye while the shutter 212 corresponding to a right eye may enable transmission of light to the right eye and vice versa. The left and right shutters 210 and 212 may be operable to close simultaneously.

The 3D shutter glasses 200 may be operable to communicate with the 3D video display device 230 to maintain clock synchronization. For example, the 3D shutter glasses 200 may be operable to maintain a slave clock that is phase locked to a master clock in the 3D video display device 230. In various exemplary embodiments of the invention, the master and slave clocks may comprise Bluetooth clocks; however, the invention is not limited in this regard. The 3D shutter glasses 200 may utilize the slave clock to control the left and right shutters 210 and 212 and to maintain synchronization with display of left and right 3D frames by the 3D video display device 230.

The shutter controller 220 in the 3D glasses 200 may comprise suitable logic, circuitry, interfaces, and/or code that may be operable to control the operation of the left and right shutters 210 and 212. In this regard, shutter control signals may be generated by the shutter controller 220 and may be communicated to the left and right shutters 210 and 212. In an exemplary embodiment of the invention, the shutters 210 and 212 may comprise LC shutters that may close and block light to a specified eye, when an appropriate voltage level from the shutter controller 220 is applied. Accurate synchronization of the left and right shutters 210 and 212 with the displayed 3D right frame 232 and the displayed 3D left frame 234 may be necessary to avoid bothersome or less than desirable flicker effects.

In operation, the 3D video display device 230 may generate left and right 3D video frames for display, such as, the displayed 3D right frame 232 and the displayed 3D left frame 234. A viewer may wear the 3D shutter glasses 200 that may be synchronized with the 3D video display device 230 when viewing the 3D video frames. At time instant 250A, the 3D video display device 230 may refresh its screen with the displayed 3D right frame 232. While the displayed 3D right frame 232 is illuminated, the shutter controller 220 in the 3D glasses 200 may enable viewing by the viewer's right eye via the right shutter 212 and may block light to a viewer's left eye with the left shutter 210. At time instant 250B, the 3D video display device 230 may refresh its screen with the displayed 3D left frame 234. While the displayed 3D left frame 234 is illuminated, the shutter controller 220 may enable viewing by the viewer's left eye via the left shutter 210 and may block light to the viewer's right eye with the right shutter 212. In various embodiments of the invention, one or more blank frames may be displayed in between illumination of the displayed 3D right frame 232 and the displayed 3D left frame 234 to avoid crosstalk, for example. The shutter controller 220 may close both shutters 210 and 212 simultaneously and/or may delay opening of a shutter, for example, at times when crosstalk or other unwanted visual effects may impair perceived image quality.

In various embodiments of the invention, the 3D shutter glasses 200 may be utilized for viewing two alternating sequences of video rather than for viewing left and right 3D video frames. For example, two people may each wear a pair of the shutter glasses 200 which may be synchronized with the video display device 230. In this regard, at a first time instant both shutters of a first viewer's glasses may open while a frame from the first video sequence is displayed and both shutters of a second viewer's glasses may close. At the next time instant, both shutters of the second viewer's glasses may open while a frame from the second video sequence is displayed and the shutters of the first viewer's glasses may close.

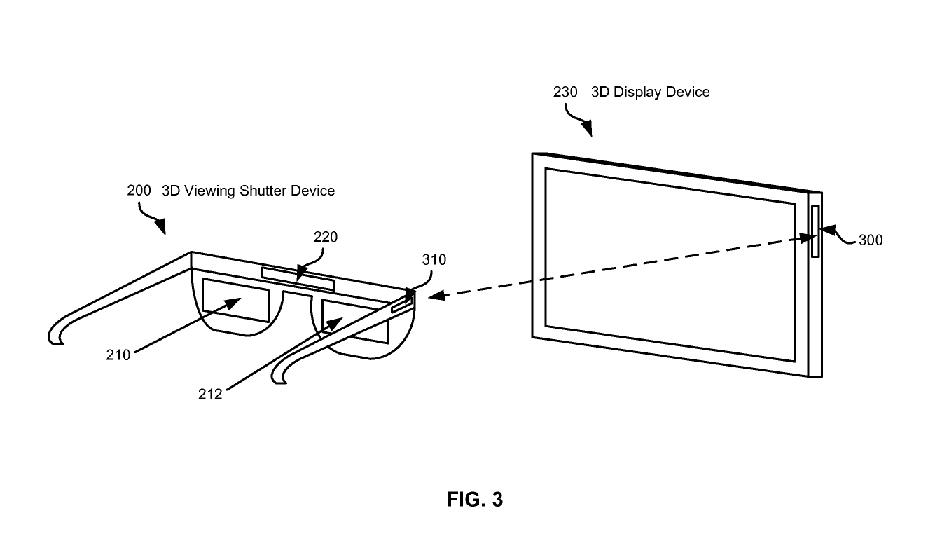

FIG. 3 is a diagram that illustrates an exemplary wireless communication link between a 3D viewing shutter device and a 3D video display device, in accordance with an embodiment of the invention. Referring to FIG. 3, there is shown the 3D video display device 230 that may comprise a first wireless device 300. Also shown is the 3D viewing shutter device 200 that may comprise the left shutter 210, the right shutter 212, the shutter controller 220 and a second wireless device 310. The 3D viewing shutter device 200 may be referred to as the 3D shutter glasses 200.

The 3D video display device 230 and the 3D shutter glasses 200 which are described with respect to FIG. 2 may be operable to communicate via a wireless link between the first wireless device 300 and the second wireless device 310. The wireless link may be utilized to communicate information that enables clock synchronization in the two devices, and/or to communicate information about when a left frame, a right frame and/or a blank frame are displayed. Moreover, the wireless link may be utilized to communicate information about when a left, right and/or blank frame sequence and/or frame pattern is displayed. Moreover, the wireless link may be utilized to communicate 3D frame refresh rates and/or an interval of time over which a pattern or sequence of left, right and/or blank frames may be displayed. In various exemplary embodiments of the invention, the wireless link may be utilized to communicate a time offset which may be utilized by the 3D shutter glasses 200 to implement a time delay before opening or closing shutters in the 3D shutter glasses 200, for example, in order to mitigate crosstalk.

The first wireless device 300 may be integrated or coupled to the 3D video display device 230 and the second wireless device 310 may integrated and/or coupled to the 3D shutter glasses 200. In instances when a projector is used to display 3D images on a screen, the first wireless device 300 may be integrated within the projector. A wireless connection may be established between the first wireless device 300 and the second wireless device 310 for viewing left and right 3D video frames through the 3D shutter glasses 200. In an exemplary embodiment of the invention, when the first wireless device 300 and the second wireless device 310 are both Bluetooth devices, the first wireless device 300 may operate a Bluetooth master clock and the second wireless device 310 may operate a Bluetooth slave clock to facilitate communication between the two devices.

In various embodiments of the invention, the second wireless device 310 may be integrated within the shutter controller 220 in the 3D shutter glasses 200. While FIG. 3 shows the second wireless device 310 as being disposed on one side of the 3D shutter glasses 200, this is merely for illustrative purposes. The second wireless device 310 may be placed on, integrated within and/or connected to any portion of the 3D glasses 200 that may enable wireless communication with the first wireless device 300.

Wireless technology that may be utilized to synchronize control of left and right shutters in the 3D shutter glasses 200 to left, right and/or blank frame image generation on a screen of the 3D video display device 230, may include, but need not be limited to, personal area network (PAN) technologies such as Bluetooth, Ultra-Wideband (UWB), Z-Wave, and ZigBee, for example. For example, in instances when the 3D shutter glasses 200 utilize Bluetooth technology, Bluetooth clocks may enable synchronization of 3D shutters glasses. Technologies that support wireless communication over the Industrial, Scientific, and Medical (ISM) 2.4 GHz radio frequency bandwidth may also be used. Similarly, technologies that support wireless communication over 900 MHz, 1.9 GHz, and 5.8 GHz, such as those technologies used in cordless phone applications, for example, may also be used to synchronize the shutter controller 220 to the image generation process in the 3D video display device 230. In various embodiments of the invention, technologies for use in wireless local area network (WLAN) applications, such as WiFi or those based on IEEE 802.11 standards, for example, may also be used to synchronize the shutter controller 220 to the image generation process in the 3D video display device 230.

In operation, the 3D video display device 230 may display 3D video and/or graphics content comprising sequential left and right view frames. A viewer may utilize the 3D shutter glasses 200 to view the sequential left and right frames. In various embodiments of the invention, the 3D shutter glasses and the 3D video display device 230 may establish a wireless connection via the first and second wireless devices 300 and 310 in order to synchronize operation of the shutters 210 and 212 with display of 3D left and right frames by the 3D video display device 230. The first wireless device 300 and the second wireless device 310 may be operable to communicate information that enables clock synchronization, and/or information about when a left, a right and/or a blank frame or sequence of frames may be displayed on the 3D video display device 230. In addition the first and second wireless devices 300 and 310 may be operable to communicate 3D frame refresh rates and/or an interval or period of time over which a pattern of left, right and/or blank frames may be displayed. The first and second wireless devices 300 and 310 may also be operable to communicate a time offset and/or a time delay for opening and/or closing shutters in the 3D shutter glasses 200. The first and second wireless devices 300 and 310 may be operable to perform two-way communication via the wireless connection. The first wireless device 310 may be operable to similarly communicate with a plurality of 3D shutter glasses. In other exemplary embodiments of the invention, the first wireless device 300 in the 3D video display device 230 may broadcast shutter sync information for reception by one or more devices such as the 3D shutter glasses 200 that may be located within communication range. In various embodiments of the invention, the 3D shutter glasses 200 may be operable to receive communication from the 3D video display device 230 but may not transmit information to the display device 230.

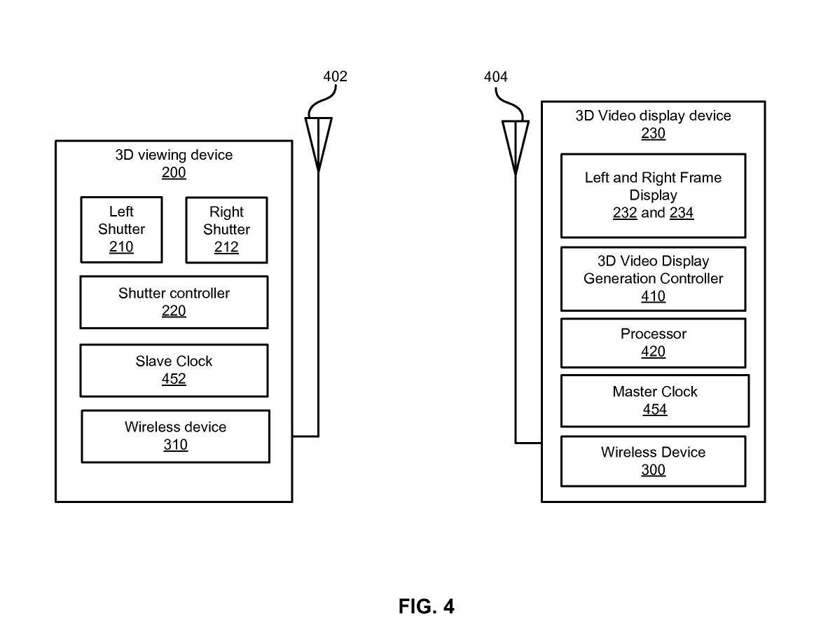

FIG. 4 is block diagrams that illustrates an exemplary 3D viewing shutter device that is operable to determine when to open and close left and right shutters based on clock and 3D frame refresh information received from a 3D video display device via a wireless link, in accordance with embodiments of the invention. Referring to FIG. 4, there is shown the 3D video display device 230 and the 3D viewing shutter device 200. The 3D video display device 230 may comprise the displayed 3D right frame 232 and the displayed 3D left frame 234, a 3D video generation controller 410, a processor 420, a master clock 454, the first wireless device 300 and an antenna 404. The 3D viewing device 200 may comprise the shutter controller 220, a slave clock 452, the second wireless device 310 and an antenna 402. The 3D viewing device 200 may be referred to as the 3D shutter glasses 200.

Aspects of the video display device 230, the displayed 3D right frame 232, the displayed 3D left frame 234, the 3D viewing device 200, the shutter controller 220, the left shutter 210, the right shutter 212 and the first and second wireless devices 300 and 310 are described with respect to FIG. 1A, FIG. 1B, FIG. 2 and FIG. 3.

The antennas 402 and 404 may comprise suitable logic, circuitry, interfaces and/or code that may be operable to transmit and/or receive signals among the 3D viewing device 200 and the 3D display device 230. For example, the antennas 402 and/or 404 may be operable to handle frequency bands that may be utilized for communication based on the wireless technologies described with respect to FIG. 2, such as for example, Bluetooth communication. The antennas 402 and 404 may be located internally and/or externally with respect to the 3D viewing device 200 and the 3D video display device 230 respectively.

In an exemplary embodiment of the invention, the 3D video display device 230 and the 3D viewing device 200 may be operable to communicate based on Bluetooth communication standards, however, the invention is not limited in this regard and any suitable standard or non-standardized wireless technology may be utilized. The video display device 230 may comprise suitable logic, circuitry, interfaces and/or code that may be operable to maintain the master clock 454. The master clock 454 may comprise a counter, for example, a counter utilized in a Bluetooth master clock. The 3D viewing device 200 may comprise the slave clock 452 which may be generated based on reference signals from the master clock 454. The slave clock 452 may be utilized as a reference clock for controlling opening and closing of the left and right shutters 210 and 212. The slave clock 452 may be phase locked to the master clock 454. For example, the phase of the slave clock 452 may be updated when packets sent by the 3D video display device 230 via the wireless first device 300 and the antenna 404 are received by the 3D shutter glasses 200 via the antenna 402 and the second wireless device 310. In this manner, the phase of the slave clock may be accurate within a few microseconds, for example. The master clock 454 and the slave clock 452 may comprise Bluetooth clocks.

The 3D video generation controller 410 may comprise suitable logic, circuitry, interfaces and or code that may be operable to generate a sequence of 3D left, right and/or blank frames that are displayed on the 3D video display device 230. For example, the 3D video generation controller 410 may be operable to generate the displayed 3D right and left frames 232 and 234. Moreover, the 3D video generation 410 may be operable to generate a pattern of frames, such as for example, the pattern of frames comprising the left view frame 104, the blank frame 106, the right view frame 108 and the blank frame 110 and/or, for example, the left frame 100 and the right frame 102. In addition, the 3D video generation controller 410 may be operable to generate a frame synchronization signal that may indicate when the 3D left, right and/or blank frames are displayed. A frame synchronization signal is described with respect to FIG. 2. For example, the 3D video generation controller may generate a square wave that may be positive when a left frame is displayed and may be negative when a right frame is displayed. Notwithstanding, the invention is not limited in this regard, and any suitable signal may be utilized.

The processor 420 may comprise suitable logic, circuitry, interfaces and/or code that may be operable to record a time instant from the master clock 454 when the display device 230 is refreshed with a new 3D left or right frame or at the beginning of a pattern or sequence of left, right and/or blank frames. For example, the processor 420 may record a time instant that is associated with a rising edge of a frame synchronization signal which may comprise a square wave. The rising edge may indicate that, for example, a left frame from the beginning of a pattern of left, right and/or blank frames is being refreshed on the 3D video display device 230. Alternatively, a vertical or horizontal sync pulse that may be generated at the beginning of a frame when a frame is written to a display, may be utilized to associate a master clock time instant with 3D frame refresh, for example. The processor 420 may be operable to communicate the recorded time instant to the 3D viewing shutter device 200. In addition, the processor 420 may be operable to communicate a time interval over which a corresponding pattern of left, right and/or blank frames is displayed on the 3D viewing device 200, via the first wireless device 300 and the antenna 404. In instances when, for example, the pattern of left, right and/or blank frames changes, the interval over which a pattern occurs changes, the display of 3D material starts or stops, or for example, a refresh rate changes, the processor 420 may communicate new information that corresponds to the changes to the 3D shutter glasses 200. These types of changes may occur when a channel is changed, for example.

In various embodiments of the invention, the processor 420 may be operable to determine a time offset for opening and/or closing left and right shutters, for example, to avoid left, right image crosstalk or other undesirable visual effects. The time offset may be dependent on the type of display utilized in the 3D video display device 230. For example, a persistent LCD display may cause the crosstalk as described with respect to FIG. 2. In this regard, the 3D video display device 230 may be operable to communicate the time offset to the 3D shutter glasses 200 via the first wireless device 300 and the antenna 404.

The shutter controller 220 in the 3D glasses 200 may be operable to receive the time instant of the beginning of a pattern of the left, right and/or blank frames, the duration of a time interval over which the pattern of left, right and/or blank frames are displayed and/or a time offset. The shutter controller 220 may utilized the received information along with reference clock signals from the slave clock 452 to determine when to open and close the left and right shutters 210 and 212. The shutter controller 220 may generate shutter control signals having phases that are tightly synchronized to the phases of the video generation process on the video display device 230. Those shutter control signals may be used to synchronize the opening and closing of the shutters 210 and 212 to the 3D video being displayed in the video display device 230.

In operation, the 3D video display device 230 may maintain a master clock 454 and may align transmissions to the 3D shutter glasses 200 with the master clock 454. The 3D shutter glasses 200 may receive the transmissions from the 3D video display device 230 via the second wireless device 310 and may phase lock the slave clock 452 utilizing the received transmissions. In this regard, the 3D shutter glasses 200 may comprise a replica of the master clock 454. The master clock 454 and/or the slave clock 452 may comprise Bluetooth clocks. The video generation controller 410 may write left, right and/or blank frames to be displayed on the 3D video display device 230 and may generate a corresponding frame synchronization signal that may indicate when the frames are refreshed and/or sustained on the display. The processor 420 may receive the frame synchronization signal and may detect when a pattern of left, right and/or blank frames may be generated. The processor 420 may be operable to record a time instant when a specified point in the pattern occurs.

The processor 420 may be operable to determine a time interval or period of the pattern. The processor 420 may be operable to determine a time offset, for example, based on the type of display utilized in the 3D video display device 230 for delaying opening and/or closing of shutters in the 3D shutter glasses 200. The processor 420 may be operable to communicate the recorded time instant, the determined time interval and/or the determined time offset, for example, to the 3D viewing device 200 via the first wireless device 300 and the antenna 404. The processor 420 may not need to send the communicated information each clock period or at each interval of a left, right and/or blank frame pattern since the 3D shutter glasses may utilize the slave clock 452 as reference along with the communicated information for determining when to open and close the left and right shutters 210 and 212 over a plurality of cycles. The frequency of communicating the information may depend on frequency drift of the slave clock 452 in the 3D shutter glasses 200 or a change of, for example, 3D frame refresh rate in the 3D video display device 230. Furthermore, processor 420 may be operable to cease transmissions of timing information to the 3D shutter glasses 200 if it determines that the video material being displayed on video display device 230 is not currently in a 3D format. Processor 420 may send a signal to 3D shutter glasses 200 indicating that the video being displayed is no longer in a 3D format. 3D shutter glasses 200 may then enter a mode where both right and left shutters are constantly opened. If processor 420 detects that 3D material is again being displayed on video display device 230, it may again send appropriate timing information to 3D shutter glasses 200 to resume the shutter switching necessary for viewing of the video material with 3D effect.

The 3D shutter glasses 200 may be operable to receive the recorded time instant, the determined time interval and/or the determined time offset via the second wireless device 310 and the antenna 402. The shutter controller 220 may be operable to determine when to open and close the left and right shutters 210 and 212 based on the received information and utilizing the slave clock 452 as a time reference. The shutter controller 220 may be operable to generate left and/or right shutter control signals that may open and close the left and right shutters 210 and 212 at suitably precise time instants such that only the left shutter 210 is open while a left frame is displayed and only the right shutter 212 is open when a right frame is displayed. In this regard, the 3D shutter glasses 200 may avoid enabling a perception of crosstalk by a viewer.

In a similar manner, the 3D video display device 230 may be operable to communicate and/or enable synchronization with a plurality of 3D shutter glasses for controlling left and right shutters in the plurality of 3D shutter glasses.

The shutter controller 220 in the 3D glasses 200 may be operable to accurately predict or determine when each 3D left and right image is to be displayed based on a single clock value (e.g., Bluetooth clock). Therefore, the clock value need not be recorded for every image displayed in the video display device 230. When a Bluetooth clock value is being used, for example, clock values may need to be recorded and communicated often enough such that the drift of the slave clock 452 and master clock 454 relative to the timing of the sequence of video images does not cause a discrepancy that may impact or affect the quality of the 3D video perceived by a viewer. By transmitting timing information only often enough to correct for this clock drift rather than for every video frame, the duty cycle of the radio communication can be made relatively low, thereby conserving energy.

Moreover, the above-described system and/or method may be highly robust against interference that may cause packets to be lost and/or retransmitted. The 3D glasses may continue to switch between right and left shutters in substantial synchronization with the video display device even though the timing of the radio communication may fluctuate. As an additional advantage, the above-described system is relatively insensitive to delays in the transmission of the timing information. The transmission delays may occur when packets are lost due to interference and are retransmitted later. Transmission delays may also occur when other radio traffic takes priority over the timing information transmissions.

The low duty cycle of the radio communication enabled by the approach described above may further keep bandwidth available for other applications to share the wireless device 300 on the video display device 230.

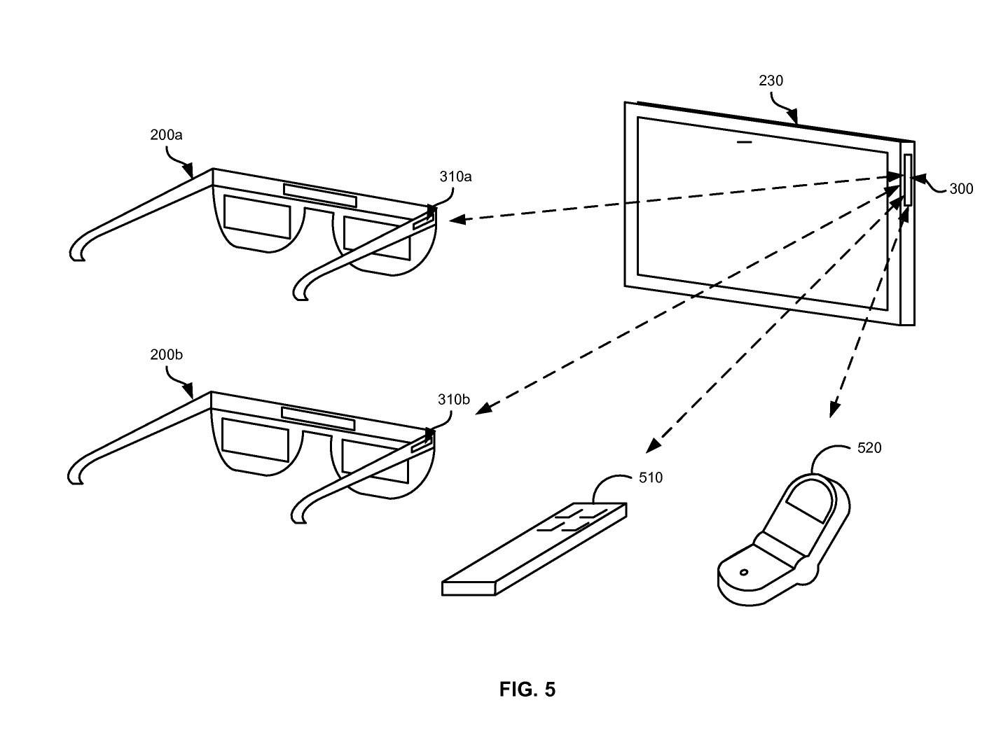

FIG. 5 is a diagram that illustrates a plurality of exemplary 3D shutter glasses and other wireless devices communicating with a 3D video display device via Bluetooth wireless connections, in accordance with an embodiment of the invention. Referring to FIG. 5, there is shown 3D shutter glasses 200a comprising a wireless device 310a, 3D shutter glasses 200b comprising a wireless device 310b, a handheld wireless communication device 510 and a mobile phone 520. In addition, there is shown the 3D video display device 230 that comprises the first wireless device 300.

The 3D shutter glasses 200a that comprise the wireless device 310a and the 3D shutter glasses 200b that comprise the wireless device 310b are similar and/or substantially the same as the 3D shutter glasses 200 that comprise the second wireless device 310.

The 3D video display device 230 may be operable to communicate with and/or enable synchronization with a plurality of 3D shutter glasses for controlling left and right shutters in the same or a similar manner as described with respect to FIG. 1A, FIG. 1B, FIG. 2, FIG. 3 and FIG. 4 for the shutter glasses 200. The 3D video display device 230 is shown in FIG. 5 as communicating with two pairs of 3D shutter glasses, however, the invention is not limited with regard to the number of 3D shutter glasses that the 3D video display device 230 may communicate with, and may utilize any suitable number of 3D shutter glasses in accordance with implementation constraints.

The handheld wireless communication device 510 which may, for example, comprise a remote control and the mobile phone 520 may comprise suitable logic circuitry and/or code that may be operable to communicate with the 3D video display device 230 via the first wireless device 300. For example, the handheld wireless communication device 510 and the mobile phone 520 may be operable to communicate based on Bluetooth communication standards with the 3D video display device 230. In instances when Bluetooth technology is utilized, the first wireless device 300 in the video display device 230, which may be used as a master device, may not only communicate with a plurality of 3D glasses, such as the 3D glasses 200a and/or the 3D glasses 200b but may also service other Bluetooth devices such as the handheld wireless communication device 510 and/or the mobile phone 520. Other Bluetooth devices which may also be serviced by the first wireless device 300 may comprise stereo headphones (not shown), surround sound speakers (not shown), or other like devices. The first wireless device 300 in the video display device 230 may also be used to receive pictures and/or videos that may be transmitted, for example, from the mobile phone 520 or a video camera (not shown), for example.

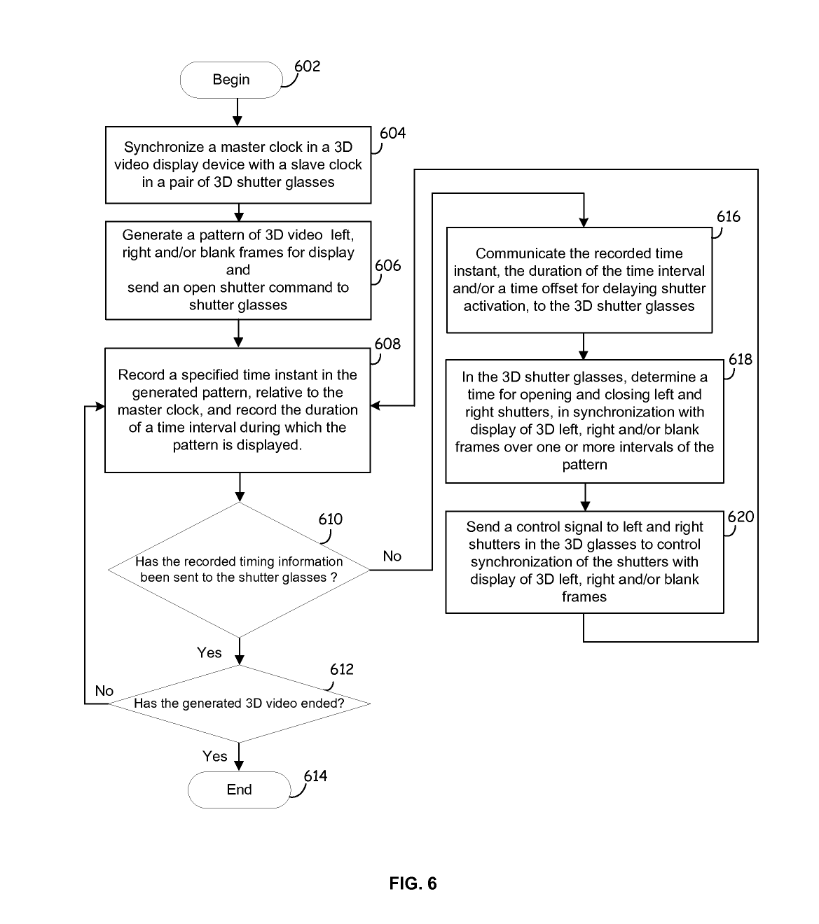

FIG. 6 is a flow chart illustrating exemplary steps for synchronizing 3D shutter glasses to a television 3D frame refresh rate, in accordance with an embodiment of the invention. Referring to FIG. 6, the exemplary steps may begin at step 602. In step 604, the slave clock 452 in the pair of 3D shutter glasses 200 may be synchronized with a master clock 454 in the 3D video display device 230. In step 606, a pattern of 3D video left, right and/or blank frames, for example, the left view frame 104, the blank frame 106, the right view frame 108 and the blank frame 110, may be generated for display by the 3D video generation controller 410 in the 3D video display device 230. In addition, a command to open shutters may be communicated to shutter glasses. In step 608, a specified time instant in the generated pattern comprising, for example, the left view frame 104, the blank frame 106, the right view frame 108 and the blank frame 110, relative to the master clock 454 may be recorded, and the duration of a time interval during which the pattern is displayed may be recorded. In step 610, in instances when the recorded timing information has already been sent to the shutter glasses, the exemplary steps may proceed to step 612. In step 612, if the generated video has ended, the exemplary steps may proceed to step 614. The exemplary steps may end at step 614.

In step 610, in instances when the recorded timing information has not been sent to the shutter glasses, the exemplary steps may proceed to step 616. In step 616, the recorded time instant, the duration of the time interval and/or a time offset for delaying activation of the shutter 210 and/or the shutter 212 may be communicated to the 3D shutter glasses 200. In step 618, in the 3D shutter glasses 200, time instants may be determined for opening and/or closing the left and right shutters 210 and 212, such that the shutters are operated in synchronization with display of the pattern of 3D left, right and/or blank frames and/or repeated displays of the pattern. In step 620, a control signal may be sent to the left and right shutters 210 and 212 in the 3D shutter glasses 200 to control synchronization of the shutters with the display of 3D left, right and/or blank frames. The exemplary steps may proceed to step 608.

In step 612, if the generated video has not ended, the exemplary steps may proceed to step 608.

In an embodiment of the invention, the 3D video viewing shutter device 200 that is wirelessly coupled to the 3D video display device 230 may generate the slave clock 452 based on the master clock 454 in the 3D video display device 230. The 3D video viewing shutter device 200 may maintain synchronization with the master clock 454. The 3D video viewing shutter device 200 may receive from the 3D video display device 230, information about display of the 3D video frames comprising the left frame 104, the blank frame 106, the right frame 108 and the blank frame 108, for example. The 3D video viewing shutter device 200 may also receive from the 3D video display device 230, time information that is referenced to the master clock 454. The time information may correspond to a time of display of the 3D video frames comprising the left frame 104, the blank frame 106, the right frame 108 and the blank frame 108, for example. The 3D video viewing shutter device 200 may determine when to open and close left and right shutters 210 and 212 to correspond to the time of the display of the 3D video frames comprising the left frame 104, the blank frame 106, the right frame 108 and the blank frame 108, for example. The determination may be based on the generated slave clock 452, the received information about the display of the 3D video frames comprising the left frame 104, the blank frame 106, the right frame 108 and the blank frame 108, for example, and/or the received time information that is referenced to the master clock 454. The slave clock 452 and the master clock 454 may comprise a Bluetooth slave clock and a Bluetooth master clock respectively. The information about the display of 3D video frames comprising the left frame 104, the blank frame 106, the right frame 108 and the blank frame 108, for example, may comprise information about a pattern of left, right and/or blank frames that are displayed on the 3D video display device 230. Furthermore, the information about the display of 3D video frames comprising the left frame 104, the blank frame 106, the right frame 108 and the blank frame 108, for example, may comprise length of a time interval that corresponds to display of a pattern of left, right and/or blank frames that are displayed on the 3D video display device 230, for example, a pattern comprising the left frame 104, the blank frame 106, the right frame 108 and the blank frame 108. The information about the display of 3D video frames comprising the left frame 104, the blank frame 106, the right frame 108 and the blank frame 108, for example, may comprise a refresh rate for displaying left, right and/or blank frames that are displayed on the 3D video display device 230. The time information that is referenced to the master clock 454 may indicate master clock 454 time that corresponds to the display of 3D video frames comprising the left frame 104, the blank frame 106, the right frame 108 and the blank frame 108, for example. The information about the display of 3D video frames comprising the left frame 104, the blank frame 106, the right frame 108 and the blank frame 108, for example, may comprise a time offset for delaying opening and/or closing of left and right shutters 210 and 211. Opening and closing of the left and right shutters 210 and 212 may be based on the generated slave clock 452, the received information about the display of 3D video frames comprising the left frame 104, the blank frame 106, the right frame 108 and the blank frame 108, for example, and the received time information that is referenced to the master clock 454. Maintaining a correspondence in time between time of the opening and closing the left and right shutters 210 and 212 and the time of the display of the 3D video frames comprising the left frame 104, the blank frame 106, the right frame 108 and the blank frame 108, for example, when new information about the display of 3D video frames, and new time information that is referenced to the master clock 454, is not received and/or not utilized. In various embodiments of the invention, information may be transmitted by the 3D video viewing shutter device 200 to the 3D video display device 230. The invention may further enable viewing of different and/or independent video streams by two or more individuals. In this regard, coordination by the master clock 454 and/or the slave clock 452, may enable opening both shutters on a first viewer's shutter glasses during display of a first frame while closing both shutters on a second viewer's glasses and during display of a second frame, closing both shutters on the first viewer's glasses while opening both shutters of the second viewer's glasses. In this regard, the first frame may correspond to a first video sequence and the second frame may correspond to a second video sequence.

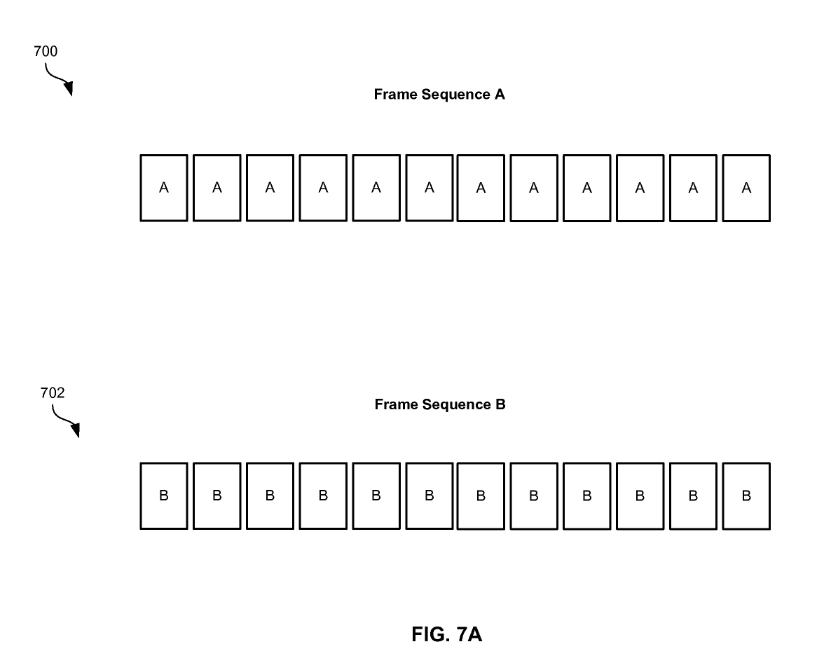

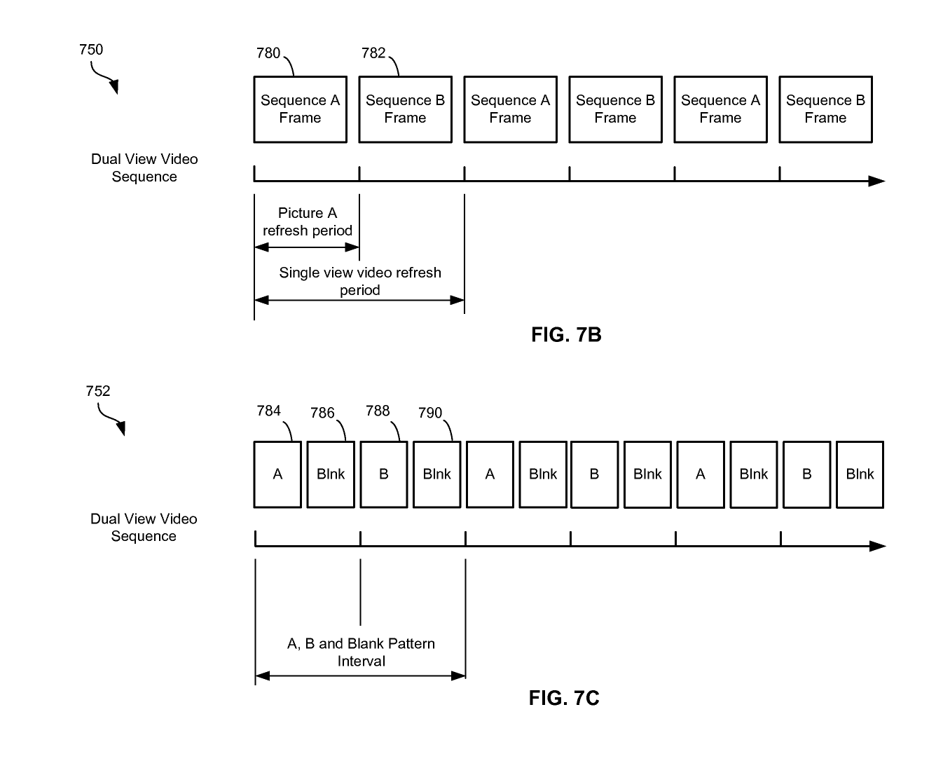

FIG. 7A is a diagram that illustrates two different and/or independent frame sequences that may comprise different and/or independent content, in accordance with an embodiment of the invention. Referring to FIG. 7A, there is shown a frame sequence A 700 and a frame sequence B 702.

The frame sequence A 700 and the frame sequence B 702 may comprise different and/or independent content. For example, the frame sequence A 700 may comprise frames from a first film and the frame sequence B 702 may comprise frames from a second film. However, the invention is not limited in this regard and the frame sequences A 700 and B 702 may comprise pictures from any suitable source. For example, the frame sequences A 700 and B 702 may comprise frames from any suitable 2D or 3D picture and/or graphics sequences, such as pictures from video, gaming, film, television, navigation maps and/or images, still images and text. Frames within the frame sequence A 700 and within the frame sequence B 702 may be referred to as sequence A frames and sequence B frames respectively. Furthermore, frames within the frame sequence A 700 and within the frame sequence 702 may be referred to as video frames or as different and/or independent video frames, for example.

FIG. 7B is a diagram that illustrates an exemplary sequence of frames that comprises frames alternating from a plurality of different and/or independent frame sequences, in accordance with an embodiment of the invention. Referring to FIG. 7B, there is shown a sequence of alternating frames 750 that comprises a sequence A frame 780 and a sequence B frame 782. The sequence A frame 780 and the sequence B frame 782 may be referred to as video frames.

The sequence A frame 780 may comprise a frame from the frame sequence A 700. The sequence B frame 782 may comprise a frame from the frame sequence B 702.

The sequence of alternating frames 750 may comprise frames that belong to two or more different and/or independent frame sequences, for example, from the sequence A 700 and the sequence B 702. In various embodiments of the invention, the sequence of alternating frames 750 may comprise frames from greater than two different video sequences and may also comprise blank or black frames. Frames from sequences A 700 and B 702 may be displayed in an alternating pattern by a multi-view video display device. Each of at least two viewers may view one of the frame sequences A 700 or B 702 utilizing shutter devices. In this regard, a shutter device for one viewer may be open when sequence A 700 frames are displayed and may be closed when frames from sequence B 702 are displayed. Concurrently, a second shutter device for a second viewer may be closed when sequence A 700 frames are displayed and may be open when sequence B 702 frames are displayed. A viewing device that utilizes a shuttering technique may be referred to as shutter glasses. In instances when there are only two different and/or independent video sequences in the sequence of alternating frames 750, such as the sequence A 700 and the sequence B 702, the shutter viewing device may be referred to as “dual view” or “multi-view” shutter glasses. In various embodiments of the invention, the same shutter device may be enabled for viewing left and right 3D video frames and for viewing frames from a plurality of independent video sequences.

In operation, the sequence A frame 780 may comprise an image from a first frame sequence 700 and the frame 782 may comprise an image from a second independent frame sequence 702. The two independent frame sequences 700 and 702 may be displayed by a single video display device and may be viewed by two or more viewers concurrently. For example, each viewer may utilize a shutter device such as dual view shutter glasses. A first viewer may view the A sequence 700 utilizing a first pair of shutter glasses in which both shutters are open during display of frames from the A sequence 700 and are closed during display of frames from the B sequence 702. A second viewer may view the B sequence 702 with shutter glasses in which both shutters are open during display of frames from the B sequence 702 and are closed during display of frames from the A sequence 700. In this manner, the invention may enable viewing of at least two independent frame sequences by two or more individuals wherein the at least two independent frame sequences are displayed by the same display device and frames from the at least two independent frame sequences are displayed in an alternating pattern. In this regard, a single stream of video may be generated by the display device, comprising the frames alternating from the at least two independent frame sequences. A display device which is configurable for displaying frames from at least two different and/or independent frame sequences that alternate within a single sequence, may be referred to as a multi-view display device, a dual view display device or a display device, for example.

Shutter devices may utilize a shuttering technique where a first shutter device may block vision by one user while a second shutter device may enable vision for a second viewer. This may be referred to as closing shutters and opening shutters. A viewing device that utilizes a shuttering technique may be referred to as shutter glasses. Shutter glasses may be worn by a viewer. Shuttering in a first shutter device may be electronically controlled such that shutters for a first viewer are open only when an image for the first viewer is being displayed on a display device, and the shutters may be closed when an image for another viewer is being displayed on the display device. When a shutter is closed, the image being displayed on the display is substantially blocked by the shutters. In various embodiments of the invention, the shutters are made using liquid crystal (LC) elements and such shutters are typically referred to as LC shutters. Notwithstanding, the invention is not so limited and other materials may be utilized.

FIG. 7C is diagram that illustrates an exemplary sequence of frames that may comprise frames from a plurality of different and/or independent frame sequences and blank frames, in accordance with an embodiment of the invention. Referring to FIG. 1B, there is shown a frame sequence 752 that comprises at least a sequence A frame 784, a blank frame 786, a sequence B frame 788 and a blank frame 790. Frames in the sequence 752 may be referred to as video frames.

The frame sequence 752 may comprise frames from a plurality of different and/or independent frame sequences, for example, the frame sequence A 700 and the frame sequence B 702, and may comprise black or blank frames, for example. The black or blank frames may not be illuminated and/or may comprise low or subdued brightness or color values and may be referred to as either black or blank frames. The blank frames may be placed or generated in between frames from the different and/or independent frame sequences. The blank frames may be utilized to reduce the effects of crosstalk caused by the different and/or independent frame sequences.

In operation, the sequence of frames 752 may be displayed by a video display device which may utilize a persistent display technology such as liquid crystal, LED, or plasma, for example. In a persistent display device, pixel illumination corresponding to a first set of data may persist until written over by a second set of data. The sequence of frames 752 may comprise frames from two or more constituent different and/or independent frame sequences, for example, frames from the frame sequence A 700 and the frame sequence B 702. The frame sequence A 700 may comprise the frame A 784 and the frame sequence B 702 may comprise the frame B 788. In this regard, the frame sequence 752 may comprise alternating images or pictures from the frame sequence A 700, blank frames and the frame sequence B 702. Moreover, one or more blank frames may be displayed between the frames from the sequences A 700 and B 702. The blank frames may prevent simultaneous display of data from the different sequences A 700 and B 702 and/or may prevent the perception of crosstalk or other visual effects by a viewer of the sequence 752. In various embodiments of the invention, the use of blank frames may be reduced or eliminated by modulating back-lighting in a video display device which is utilized to display the frames, for example, an LCD display device. The backlighting may be utilized during periods when pixels from a portion of a previous frame and pixels from a portion of a subsequent frame are illuminated at the same time, for example, when the subsequent frame is being written to the screen.

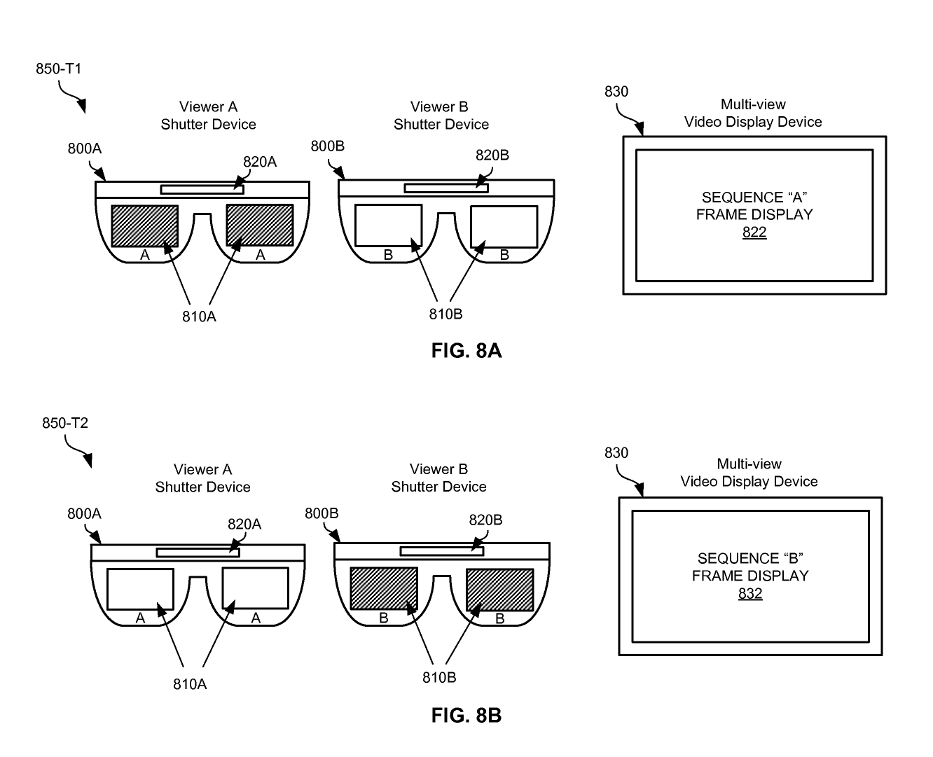

FIGS. 8A and 8B are diagrams that illustrate exemplary synchronization among a plurality of shutter viewing devices at time instants T1 and T2, in accordance with an embodiment of the invention. Referring to FIGS. 8A and 8B there is shown two shutter viewing devices 800A and 800B which may be referred to as shutter devices or shutter glasses, and a video display device 830. The FIG. 8A represents a time instant 850-T1 and the FIG. 8B represents a time instant 850-T2. The shutter device 800A comprises shutters 810A and a shutter controller 820A. The shutter device 800B may comprise shutters 810B and a shutter controller 820B. In addition, there is shown, a video display device 830. In FIG. 8A, a sequence A frame 822 is shown and in FIG. 8B, a sequence B frame 832 is shown. The shutter devices 800A and 800B and the video display device 830 are shown at time instant 850-T1 in FIG. 8A and at time instant 850-T2 at FIG. 8B.

The sequence A frame 822 may be a frame from a frame sequence A and the frame sequence B frame 832 may be from a frame sequence B. The frame sequences A and B may comprise different and/or independent content. The sequence A frame 822 and the sequence B frame 832 may be referred to as video frames.

The video display device 830 may comprise suitable logic, circuitry, interfaces and/or code that may be operable to display time sequential frames comprising frames from a plurality of different and/or independent frame sequences. The video display device 830 may be referred to as a multi-view display device, a dual view display device or a display device, for example. The video display device 830 may be operable to display the sequence of frames 750 and/or the sequence of frames 752. In various embodiments of the invention, the video display device 830 may be operable to display 2D and/or 3D video and may be the same or substantially similar to the video display device 230 shown in FIG. 2. The invention is not limited to any specific type of display device technology and may utilize any suitable type of display device, for example, a liquid crystal display (LCD), a rear projector display or a plasma display may be utilized. Exemplary embodiments of the video display device 830 may comprise a television, a computer monitor, a gaming device, a navigation device and/or a video projector, however, the invention is not limited in this regard.

A plurality of viewers may utilize the shutter devices 800A and 800B to watch a plurality of videos or video streams on the same display and may perceive that they are viewing a plurality of different and/or independent videos concurrently on the same display device and/or within the same view port of the same display device. The video display device 830 may be operable to communicate with the shutter devices 800A and/or 800B to synchronize shutters 810A and 810B with display of corresponding different and/or independent frame sequences on the display device 830. For example, the shutter device 800A may be operable to open shutters 810A during display of a first frame sequence such as during display of frames from a frame sequence A and may be operable to close shutters 810A during display of frames from a second frame sequence B. Similarly, the shutter device 800B may be operable to open shutters 810B during display of the second frame sequence such as during display of frames from the frame sequence B and may be operable to close shutters 810B during display of frames from the first frame sequence A. The shutter devices 800A and 800B may comprise shutter glasses and may be referred to as the shutter glasses 800A and 800B, for example. In addition, the shutter devices 800A and 800B may be referred to as video viewing shutter devices. The shutter devices 800A and 800B may be operable to synchronize with the display 830 in a similar manner as the 3D shutter viewing device 200 synchronizes with the display device 230.

In various embodiments of the invention, the display device 830 and the shutter devices 800A and 800B may be operable to communicate via Bluetooth connections. Communication between the display and shutter devices may be synchronized with a master clock in the display device 830 and slave clocks in the shutter devices 800A and/or 800B. For example, the shutter devices 800A and 800B may each comprise slave clocks which may be kept synchronized to a master clock in the display device 830. The master and/or slave clocks may comprise master and slave Bluetooth clocks; however, the invention is not limited with regard to the type or source of a clock signal and may utilize any suitable clock mechanism.

In accordance with the Bluetooth wireless standard, for any connection between two Bluetooth-enabled devices, one device may take on the role of master device while the other may take on the role of slave device. At any instant in time, there may be multiple slave devices and a single master device. The master device may maintain a free-running counter, typically referred to as a Bluetooth clock. The slave device may maintain a copy of this counter, which the slave device phase-locks to the Bluetooth clock on the master device to within a few microseconds, for example. The phase of the slave clock may, in some embodiments, be updated when the slave device receives a packet from the master device. The Bluetooth clocks may, therefore, provide a time reference that may be utilized to synchronize processes on both sides of the Bluetooth link. In this manner, the Bluetooth clocks may be utilized to synchronize shutters 810A in the shutter device 800A with the display device 830, to be open at time instant 850-T1 during display of the sequence A frame 822 and to be closed at time instant 850-T2 during display of the sequence B frame 832. Similarly, Bluetooth clocks may be utilized to synchronize shutters 810B in the shutter device 800B with the display device 830, to be open at time instant 850-T2 during display of the sequence B frame 832 and to be closed at time instant 850-T1 during display of the sequence A frame 822.

The video display device 830 may comprise suitable logic, circuitry, interfaces and/or code that may be operable to determine when a sequence A frame, a sequence B frame and/or a blank frame is being displayed and may be operable to generate a signal that indicates when sequence A frames, sequence B frames and/or blank frames are displayed. The generated signal may be referred to as a frame synchronization signal. For example, a square wave may be generated that may measure as positive when a sequence A frame is displayed and may measure as negative when a sequence B frame is displayed. Notwithstanding, the invention is not limited in this regard, and any suitable frame synchronization signal or indicator of a sequence A frame, a sequence B frame and/or blank frame generation may be utilized. The display device 830 may record a time that is associated with a certain event in the frame synchronization signal or associated with a certain event that occurs when displaying sequence A, sequence B and/or blank frames. For example, the display device 830 may record a time instant when a positive rising edge of a generated signal may indicate that a sequence A frame is being refreshed on the display device 830. The display device 830 may communicate the recorded time instant to the shutter device 800A and/or the shutter device 800B. Similarly, the display device 830 may record a time instant when a positive rising edge of a generated signal may indicate that a sequence B frame is being refreshed and may communicate the time instant to the shutter devices 800A and/or 800B.

The shutter devices 800A and/or 800B may comprise suitable logic, circuitry, interfaces and/or code that may be operable to synchronize opening and closing of both shutters 810A and/or both shutters 810B with sequence A and sequence B frame refresh rates of a display device 830 display screen. The shutter devices 800A and 800B may be utilized to view different and/or independent video and/or graphics sequences on the display device 830 by a plurality of viewers. The shutter devices 800A and/or 800B may be similar or may be the same shutter devices as the 3D viewing shutter device 200 however, the shutter devices 800A and/or 800B may be configured to view a plurality of different and/or independent video streams by a plurality over viewers. The shutter devices 800A and/or 800B may be referred to as the shutter glasses 800A and/or 800B.

In an exemplary pair of shutter glasses 800A, the shutters 810A may correspond to left and right eyes of a first viewer and may enable transmission of light to both left and right eyes of the first viewer at time instant 850-T1. The shutter glasses 800A may block light to both the left and the right eyes of the first viewer at time instant 850-T2. The left and right shutters 810A may also, be operable to close concurrently. Similarly, in an exemplary pair of shutter glasses 800B, the shutters 810B may correspond to left and right eyes of a second viewer. The shutters 810B may block light to both the left and the right eyes of the second viewer at time instant 850-T1 and/or may enable transmission of light to both the left and the right eyes of the second viewer at time instant 850-T2. The left and the right shutters 810B may also, be operable to close concurrently.

The shutter glasses 800A and/or 800B may be operable to communicate with the display device 830 to maintain clock synchronization. For example, the shutter glasses 800A and/or 800B may each be operable to maintain a slave clock that is phase locked to a master clock in the display device 830. In various exemplary embodiments of the invention, the master and the slave clocks may comprise Bluetooth clocks; however, the invention is not limited in this regard. The shutter glasses 800A and/or 800B may utilize the slave clocks to control the shutters 810A and 810B respectively and to maintain synchronization with display of sequence A frames and sequence B frames by the display device 830.

The shutter controllers 820A and 820B in the shutter glasses 800A and 800B respectively may comprise suitable logic, circuitry, interfaces, and/or code that may be operable to control the operation of the shutters 810A and 810B respectively. In this regard, shutter control signals may be generated by the shutter controllers 820A and 820B and may be communicated to the shutters 810A and 810B respectively. In an exemplary embodiment of the invention, the shutters 810A and/or 810B may comprise LC shutters that may close and block light to both eyes of a specified viewer when an appropriate voltage level from the corresponding shutter controller 820A or 820B is applied. Accurate synchronization of the shutters 810A and/or 810B with the displayed sequence A frame 822 and the displayed sequence B frame 832, may enable a plurality of viewers to view a plurality of different and/or independent frame sequences on the display 830 and/or in the same display port concurrently.

In operation, the video display device 830 may generate sequence A and sequence B frames for display, for example, the displayed sequence A frame 822 and the sequence B frame 832 may be generated. Frames from sequence A and sequence B may be interleaved and/or alternated with each other and/or with blank frames. A first viewer may wear the shutter glasses 800A which may be synchronized with the display device 830 for viewing video comprising sequence A frames. A second viewer may wear the shutter glasses 800B that may be synchronized with the display device 830 for viewing video comprising sequence B frames. At time instant 850-T1, the display device 830 may refresh its screen with the displayed sequence A frame 822. While the displayed sequence A frame is illuminated, the shutter controller 820A in the shutter glasses 800A may enable viewing by both eyes of the first viewer via the shutters 810A. At the same time instant 850-T1, the shutter glasses 800B may block light to both eyes of a second viewer utilizing the shutters 810B. At the time instant 850-T2, the display device 830 may refresh its screen with the displayed sequence B frame 832. While the displayed sequence B frame 832 is illuminated, the shutter controller 820B may enable viewing by both eyes of the second viewer via the shutters 810B. Also at time instant 850-T2, the shutter glasses 810A may block light to both of the first viewer's eyes with the shutters 810A.

In various embodiments of the invention, one or more blank frames may be displayed in between illumination of the displayed sequence A frame 822 and the displayed sequence B frame 832 to avoid crosstalk, for example. The shutter controllers 820A and/or 820B may close both shutters 810A and 810B respectively, simultaneously and/or may delay opening of shutters 810A and/or 810B respectively, for example, at times when crosstalk or other unwanted visual effects may impair perceived image quality. In various embodiments, more that one shutter device may be synchronized to view a single frame sequence. For example, three viewers may utilize three shutter devices to view the frame sequence A while one viewer may utilize another shutter device to view the frame sequence B. The invention is not limited to any specific number of shutter devices utilized for viewing a frame sequence. Also, in various embodiments of the invention, the display device 830 may be operable to display more than two alternating different and or independent frame sequences. In this regard, more than two viewers may view the more than two different and/or independent frame sequences utilizing more than two shutter devices.

In various embodiments of the invention, the use of blank frames for crosstalk mitigation may be replaced and/or augmented by modulating back-lighting in the video display device 830 which may be, for example, an LCD type display device. The back-light modulation may be utilized during brief periods when pixels from a portion of a previous frame and pixels from a portion of a subsequent frame are illuminated at the same time, for example, when the subsequent frame is being written to the screen. In this regard, the shutters of both shutter devices 800A and 800B may be open at the same time for a brief period during transition between a sequence A frame and a sequence B frame. The video display device 830 may turn off back-lighting during these brief periods to mitigate the perception of crosstalk from illumination of the two frames at the same time. Similarly, the video display device 830 may modulate back-lighting during brief periods when transitioning between display of a right frame and a left frame and when both shutters in a 3D shutter device may briefly be open at the same time.

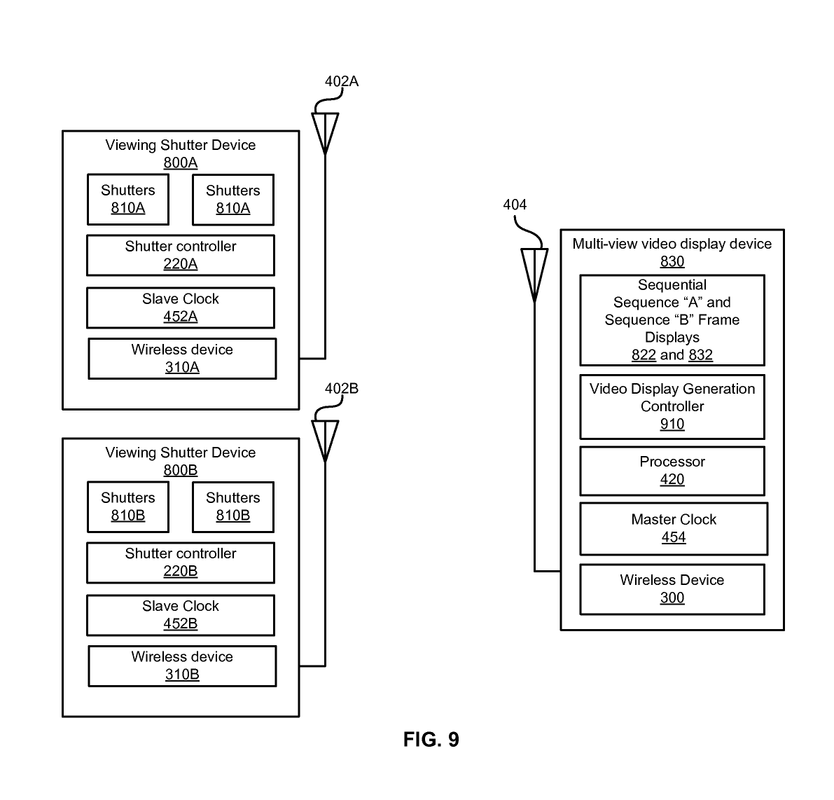

FIG. 9 is a diagram that illustrates exemplary viewing shutter devices that are operable to determine when to open and close shutters based on information received from a video display device via a wireless link, in accordance with an embodiment of the invention. Referring to FIG. 9, there is shown the video display device 830 that may comprise the displayed sequence A frame 822 and the displayed sequence B frame 832, a video display generation controller 910, the processor 420, the master clock 454, the first wireless device 300 and the antenna 404. Also shown are the two viewing shutter devices 800A and 800B that may comprise the shutters 810A and 810B respectively, the shutter controllers 220A and 220B respectively, the slave clocks 452A and 452B respectively, the secondary wireless devices 310A and 310B respectively and the antennas 402A and 402B respectively. The viewing shutter devices 800A and 800B may be referred to as shutter glasses, shutter devices and/or dual view shutter glasses.

Aspects of the video display device 830 and the viewing shutter devices are described with respect to FIGS. 7A, 7B, 7C, 8A and 8B.

The video display device 830 may be the same and/or substantially similar to the video display device 230 described with respect to FIGS. 2, 3, 4, 5 and 6. The video display device 230 may be operable to generate and/or display video that comprises alternating frames from a plurality of different and/or independent frame sequences, for example, the frame sequence 750 and/or the frame sequence 752 described with respect to FIGS. 7B and 7C.

The two viewing shutter devices 800A and 800B may be the same and/or substantially similar to the 3D shutter device 200 which is described with respect to FIGS. 2, 3, 4, 5 and 6. The two viewing shutter devices 800A and 800B may be operable to synchronize opening and/or closing of shutters with display of a plurality of different and/or independent frame sequences by the video display device 830. In this regard, the shutter device 800A may synchronize shutters with display of a first frame sequence and the shutter device 800B may synchronize with display of a second frame sequence. The display of frames from the first and second sequences may be interleaved and/or alternated over time and may be interleaved with blank frames.

The video display device 830 and one or more shutter devices, for example, the shutter devices 800A and 800B may be communicatively coupled and/or operable to communicate via wireless links. In this regard, the first wireless device 300 in the video display device 830 may be operable to communicate with the secondary wireless devices 310A and 310B in the shutter devices 800A and 800B respectively via the wireless links. The wireless links may be utilized to communicate information that enables clock synchronization between the video display device 830 and the one or more shutter devices 800A and 800B. The wireless links may be utilized to communicate information about when frames are displayed by the video display device 830, for example, frames from a particular sequence such as from the sequence A 700, the sequence B 702 and/or blank frames. Moreover, the wireless links may be utilized to communicate information about display of a frame pattern, for example, an A, blank, B, blank, A, blank, B, blank temporal pattern of frame display. The wireless links may be utilized to communicate frame refresh rates and/or an interval of time over which a pattern or sequence of A, B and/or blank frames may be displayed, for example. In various exemplary embodiments of the invention, the wireless links may be utilized to communicate one or more time offsets which may be utilized by the shutter glasses 800A and/or 800B to implement time delays before opening and/or closing shutters in the shutter glasses 800A and/or 800B, for example, in order to mitigate crosstalk among a plurality of frames from different and/or independent frame sequences.

The first wireless device 300 may be integrated with or coupled to the video display device 830 and the secondary wireless devices 310A and 310B may integrated and/or coupled to the shutter glasses 800A and 800B respectively. In instances when a projector is used to display images on a screen, the first wireless device 300 may be integrated within the projector. A wireless connection may be established between the first wireless device 300 and the secondary wireless devices 310A and 310B for viewing different and/or independent frame sequences via the shutter glasses 800A and 800B. In an exemplary embodiment of the invention, when the first wireless device 300 and the secondary wireless devices 310A and/or 310B are Bluetooth devices, the first wireless device 300 may operate a Bluetooth master clock and the secondary wireless devices 310A and/or 310B may operate Bluetooth slave clocks to facilitate communication between the display device 830 and one or more shutter devices such as 810A and 310B.

In various embodiments of the invention, the secondary wireless devices 310A and 310B may be integrated within the shutter controllers 220A and 220B respectively. Notwithstanding, the second wireless devices 310A and/or 310B may be placed on, integrated within and/or connected to any portion of the shutter glasses 800A and/or 800B respectively, that may enable wireless communication with the first wireless device 300.

Wireless technology that may be utilized to synchronize control of shutters in the shutter glasses 800A and/or 800B, to display by the video display device 830, of alternating frames from different and/or independent frame sequences may include but need not be limited to, personal area network (PAN) technologies such as Bluetooth, Ultra-Wideband (UWB), Z-Wave, and ZigBee, for example. For example, in instances when the shutter glasses 800A and/or 800B utilize Bluetooth technology, Bluetooth clocks may enable synchronization of shutters glasses. Technologies that support wireless communication over the Industrial, Scientific, and Medical (ISM) 2.4 GHz or 5 GHz radio frequency bands may also be used. Similarly, technologies that support wireless communication over 800-900 MHz, 1.8-1.9 GHz, and 5.8 GHz, such as those technologies used in wireless and cordless phone applications, for example, may also be used to synchronize the shutter controllers 220A and/or 220B to the image generation process in the video display device 830. In various embodiments of the invention, technologies for use in wireless local area network (WLAN) applications, such as WiFi or those based on IEEE 802.11 standards, for example, may also be used to synchronize the shutter controllers 220A and/or 220B to the image generation process in the video display device 830. The invention is not limited with regard to any specific type of wireless technology or any specific frequency bands, for example, infrared and/or optical technologies may be utilized to enable communication.

In an exemplary operation, the video display device 830 may display a video and/or graphics stream comprising content from a plurality of different and/or independent sources, for example, from the frame sequence A 700 and the frame sequence B 702. A plurality of viewers may each utilize a shutter device, for example, the shutter devices 800A and/or 800B. The plurality of viewers may each view, concurrently, the video and/or graphics stream comprising content from the plurality of different and/or independent sources where content from a specified source may be filtered by a viewer's shutter device. In various embodiments of the invention, the shutter glasses 800A and/or 800B and the video display device 830 may be operable to establish wireless connections via the secondary wireless devices 310A and/or 310B and the wireless device 300. The wireless connections may be utilized to synchronize operation of the shutters 810A and/or 810B with display of alternating frames from different and/or independent frame sequences, displayed by the video display device 830.

The first wireless device 300 may be operable to communicate information that enables clock synchronization with a plurality of secondary wireless devices, for example, the secondary wireless device 310A and/or the secondary wireless device 310B. For example, the first wireless device 300 and one or both of the secondary wireless devices 310A and 310B may communicate information regarding when an A sequence 700 frame, a B sequence 702 frame and/or a blank frame may be displayed by the video display device 830. The first wireless devices 300 may be operable to communicate frame refresh rates and/or an interval or period of time over which a temporal pattern comprising one or more sequence A frames, one or more sequence B frames and/or one or more blank frames may be displayed. The first wireless device 300 and one or more secondary wireless devices 310A and/or 310, may be operable to communicate a time offset and/or a time delay for opening and/or closing shutters in the shutter glasses 800A and/or 800B. The first wireless device 300 and one or more secondary wireless devices 310A and/or 310 may be operable to perform two-way communication via the wireless connections. The first wireless device 300 may be operable to similarly communicate with greater than two shutter glasses. In other exemplary embodiments of the invention, the first wireless device 300 in the video display device 830 may broadcast shutter sync information for reception by one or more shutter devices such as the shutter glasses 800A and 800B that may be located within communication range. In various embodiments of the invention, the shutter glasses 800A and/or 800B may be operable to receive communication from the video display device 830 but may not transmit information to the display device 830.

The antennas 402A, 402B and 404 may be similar and/or substantially the same as the antennas 402 and 404 described with respect to FIG. 4.

In an exemplary embodiment of the invention, the video display device 830 and the shutter devices 800A and/or 800B may be operable to communicate based on Bluetooth communication standards, however, the invention is not limited in this regard and any suitable standard or non-standardized wireless technology may be utilized. The video display device 830 may comprise suitable logic, circuitry, interfaces and/or code that may be operable to maintain the master clock 454. The master clock 454 may comprise a counter, for example, a counter utilized in a Bluetooth master clock. The shutter devices 800A and/or 800B suitable logic, circuitry, interfaces and/or code and may comprise the slave clocks 452A and 452B respectively, which may be generated based on reference signals from the master clock 454. The slave clock 452A may be utilized as a reference clock for controlling opening and closing of the shutters 810A. For example, the shutters 810A may be opened and/or closed, together at the same time, in synch with display of frames from a particular frame sequence, for example, A or B frames. Similarly, the slave clock 452B may be utilized as a reference clock for controlling opening and closing shutters 810B. The slave clocks 452A and 452B may be phase locked to the master clock 454. For example, the phase of the slave clocks 452A and/or 452B may be updated when packets sent by the video display device 830 via the wireless first device 300 and the antenna 404 are received by the shutter glasses 800A and/or 800B via the antennas 402A and/or 402B respectively and via the secondary wireless devices 310A and/or 310B respectively. In this manner, the phase of the slave clocks may be accurate within a few microseconds, for example. The master clock 454 and the slave clocks 452A and/or 452B may comprise Bluetooth clocks.

The video display generation controller 910 may comprise suitable logic, circuitry, interfaces and or code that may be operable to generate video comprising a sequence of frames where the sequence of frames comprises alternating frames from a plurality of different and/or independent frame sequences and/or blank frames. The frames in the generated video may be referred to as video frames. The generated video may be displayed by the display device 830. For example, the video display generation controller 910 may be operable to generate the displayed sequence A frame 822 and/or the displayed sequence B frame 832. Moreover, the video display generation controller 910 may be operable to generate a temporal pattern of frames, such as for example, the sequence of frames 750 and/or the sequence of frames 752. In addition, the video display generation controller 910 may be operable to generate one or more frame synchronization signals that may indicate when a particular frame and/or pattern of frames are displayed by the video display device 830. Frame synchronization signals are described with respect to FIG. 2, FIG. 8A and FIG. 8B. For example, the video display generation controller may generate a square wave that may be positive when a first frame from a first sequence is displayed and may be negative when a second frame from a second sequence is displayed. Notwithstanding, the invention is not limited in this regard, and any suitable signal may be utilized.

Aspects of the processor 420 are described with respect to FIG. 4. The processor 420 may be utilized to synchronize display of frames from a plurality of different and/or independent frame sequences, which may be interleaved and/or alternated in a displayed video stream, with a plurality of shutter devices that are utilized by a plurality of users. The processor 420 may comprise suitable logic, circuitry, interfaces and/or code that may be operable to record a time instant from the master clock 454 that corresponds to displaying a new frame or displaying the beginning of a pattern or sequence of frames by the display device 830. For example, the processor 420 may record a time instant that is associated with a rising edge of a frame synchronization signal which may comprise a square wave. The rising edge may indicate that, for example, a frame from the beginning of a pattern comprising sequence A frames, sequence B frames and/or blank frames, for example, is being refreshed by the video display device 830. Alternatively, a vertical or horizontal sync pulse that may be generated at the beginning of a frame when a frame is written to a display screen, may be utilized to associate a master clock time instant with a frame refresh, for example. The processor 420 may be operable to communicate the recorded time instant to the viewing shutter devices 800A and/or 800B. In addition, the processor 420 may be operable to communicate a time interval over which a corresponding pattern of sequence A, sequence B and/or blank frames is displayed by the video display device 830, via the first wireless device 300 and the antenna 404. In instances when, for example, one or more of the pattern of sequence A, sequence B and/or blank frames changes, the interval over which a pattern occurs changes, the display of sequence A and/or sequence B frames starts or stops, or for example, a refresh rate changes, the processor 420 may communicate new information that corresponds to the changes to the shutter glasses 800A and/or 800B. These types of changes may occur when a channel is changed on the display device 830, for example.

In various embodiments of the invention, the processor 420 may be operable to determine a time offset for opening and/or closing shutters in one or more shutter devices, for example, the shutter devices 800A and/or 800B. In this manner, the processor 420 may avoid image crosstalk or other undesirable visual effects among the plurality of sequences such as the sequence A and the sequence B, that may be perceived by one or more viewers. The time offset may be dependent on the type of display utilized in the video display device 830. For example, a persistent LCD display may cause crosstalk as described with respect to FIG. 2 and with respect to FIGS. 8A and 8B. In this regard, the video display device 830 may be operable to communicate the time offset to the shutter glasses 800A and/or 800B via the first wireless device 300 and the antenna 404.

Aspects of the shutter controllers 220A and 220B are described with respect to FIGS. 2, 3, 4, 8A and 8B, for example. The shutter controllers 220A and 220B may be operable to receive one or more of a time instant corresponding to the beginning of a pattern of the sequence A, the sequence B and/or the blank frames, the duration of a time interval over which a pattern of frames are displayed and/or a time offset, for example. The shutter controllers 220A and/or 220B may utilize the received information along with reference clock signals from the slave clocks 452A and/or 452B respectively, to determine when to open and close the shutters 810A and 810B, respectively. The shutter controllers 220A and/or 220B may generate shutter control signals having phases that are tightly synchronized to the phases of the video generation process by the video display device 830. Those shutter control signals may be used to synchronize the opening and closing of the shutters 810A in the shutter device A and the shutters 810B in the shutter device 800B to the respective display of sequence A 700 frames and sequence B 702 frames being displayed in an alternating sequence by the video display device 830.

In operation, the video display device 830 may maintain a master clock 454 and may align transmissions to the shutter glasses 800A and/or 800B with the master clock 454. The shutter glasses 800A and/or 800B may receive the transmissions from the video display device 830 via the second wireless device 310 and may phase lock the slave clocks 452A and/or 452B respectively, utilizing the received transmissions. In this regard, the shutter glasses 800A and/or 800B may comprise a replica of the master clock 454. The master clock 454 and/or the slave clocks 452A and/or 452B may comprise Bluetooth clocks. The video generation controller 410 may write sequence A 700, sequence B 702 and/or blank frames to be displayed on the video display device 830 and may generate a corresponding frame synchronization signal that may indicate when the frames are refreshed and/or sustained on the display. The processor 420 may receive the frame synchronization signal and may detect when a pattern comprising alternating sequence A, sequence B and/or blank frames may be generated. The processor 420 may be operable to record a time instant when a specified point in the pattern occurs. The shutters in the shutter glasses 800A may open at different times than the shutters in the shutter glasses 800B. For example, the shutters in the shutter glasses 800A may open during display of sequence A frames and the shutters in the shutter glasses 800B may be closed during display of the sequence A frames. The shutters in the shutter glasses 800B may be open during display of sequence B frames and may be closed during display of sequence A frames.

The processor 420 may be operable to communicate synchronization information to the viewing shutter devices 800A and/or 800B. The processor 420 may be operable to determine a time interval or time period of a pattern comprising sequence A, sequence B and/or blank frames. The processor 420 may be operable to determine time offsets, for example, based on the type of display utilized in the video display device 830 for delaying opening and/or closing of shutters in the shutter glasses 800A and/or 800B. The processor 420 may be operable to communicate synchronization information such as the recorded time instant, the determined time interval and/or the determined time offset, for example, to the viewing shutter devices 800A and/or 800B via the first wireless device 300 and the antenna 404, for example. The processor 420 may not need to send the communicated information at each clock period or at each interval of a sequence A, sequence B and/or blank frame pattern since the shutter glasses 800A and/or 800B may utilize the slave clocks 452A and/or 452B respectively as references, along with the communicated information for determining when to open and close the respective shutters 810A and/or 810B over a plurality of cycles.

The frequency of communicating the synchronization information may depend on frequency drift of the slave clock 452A and/or of the slave clock 452B. The frequency of communicating the synchronization information may depend on a change of, for example, frame refresh rate in the video display device 830. The processor 420 may be operable to cease transmissions of timing information to the shutter glasses 800A and/or 800B in instances when it determines that the video material being displayed on video display device 830 is not currently in a format which requires a shutter device for viewing, for example, a dual view format. The processor 420 may send signals to the shutter glasses 800A and/or 800B indicating that the video being displayed is no longer in a dual view format, for example. The shutter glasses 800A and/or 800B may then enter a mode where shutters 810A and 810B in both shutter devices are constantly opened. In instances when the processor 420 detects that dual view material is again being displayed on video display device 830, it may again send appropriate timing information to shutter glasses 800A and/or 800B to resume the shutter switching necessary for viewing corresponding frames from a plurality of different and/or independent frame sequences. The invention is not limited to display of a video stream comprising frames from two different and/or independent frame sequences and may comprise display of frames from greater than two different and/or independent frame sequences. Furthermore, the video display device 830 may comprise a plurality of wireless devices, such as the wireless device 300 that may each communicate with one or more of a plurality of viewing shutter devices such as the shutter devices 800A and/or 800B. Moreover, the video display device 830 may comprise a plurality of master clocks such as the master clock 454, where each master clock may correspond to a different slave clock in one or more viewing shutter device and/or each of the plurality of master clocks may correspond to synchronization information for each of a plurality of different and/or independent frame sequences.

The shutter glasses 800A and/or 800B may be operable to receive the synchronization information from the video display device 830. For example, the shutter glasses 800A and/or 800B may be operable to receive the recorded time instant, the determined time interval and/or the determined time offset, via the secondary wireless devices 310A and/or 310B respectively. The shutter controllers 220A and/or 220B may be operable to determine when to open and close the shutters 810A and 810B respectively, based on the received information. The shutter controllers 220A and/or 220B may utilize the slave clocks 452A and/or 452B respectively as a time reference. The shutter controllers 220A and/or 220B may each be operable to generate shutter control signals that cause the shutters 810A and/or the shutters 810B respectively, to open and close at suitably precise time instants such that the shutters 810A are open and shutters 810B are closed while a sequence A frame is displayed and the shutters 810B are open and the shutters 810A are closed when a sequence B frame is displayed. In this manner, the shutter glasses 800A and/or 800B may prevent a perception of crosstalk among the different and/or independent frame sequences, by one or more viewers.

In a similar manner, the video display device 830 may be operable to communicate synchronization information and/or enable synchronization with a plurality of shutter glasses for controlling shutters in the plurality of shutter glasses.

The shutter controllers 220A and/or 220B in the shutter glasses 800A and/or 800B may be operable to accurately predict or determine when each sequence A frame and/or sequence B frame is to be displayed based on a clock value (e.g., Bluetooth clock). Therefore, the clock value need not be recorded for every image displayed by the video display device 830. When a Bluetooth clock value is being used for synchronization, for example, clock values may need to be recorded and communicated often enough such that the drift of the slave clocks 452A and/or 452B and the master clock 454, relative to the timing of the sequence of video images, does not cause a discrepancy that may impact or affect the quality of the plurality of frames sequences perceived by the plurality of viewers. By transmitting timing information only often enough to correct for this clock drift rather than for every video frame, the duty cycle of the radio communication can be made relatively low, thereby conserving energy.

Moreover, the above-described system and/or method may be highly robust against interference that may cause packets to be lost and/or retransmitted. The shutter glasses 800A and/or 800B may continue to switch according to display of sequence A frames and display of sequence B frames in substantial synchronization with the video display device 830 even though the timing of the radio communication may fluctuate. As an additional advantage, the above-described system is relatively insensitive to delays in the transmission of the timing information. The transmission delays may occur when packets are lost due to interference and are retransmitted later. Transmission delays may also occur when other radio traffic takes priority over the timing information transmissions.

The low duty cycle of the radio communication enabled by the approach described above may further keep bandwidth available for other applications to share via the wireless device 300 on the video display device 830. The low duty cycle of the radio communication enabled by the approach described above may additionally allow other wireless devices in or near video display 830 which might otherwise interfere with the operation of wireless device 300 to operate more frequently.

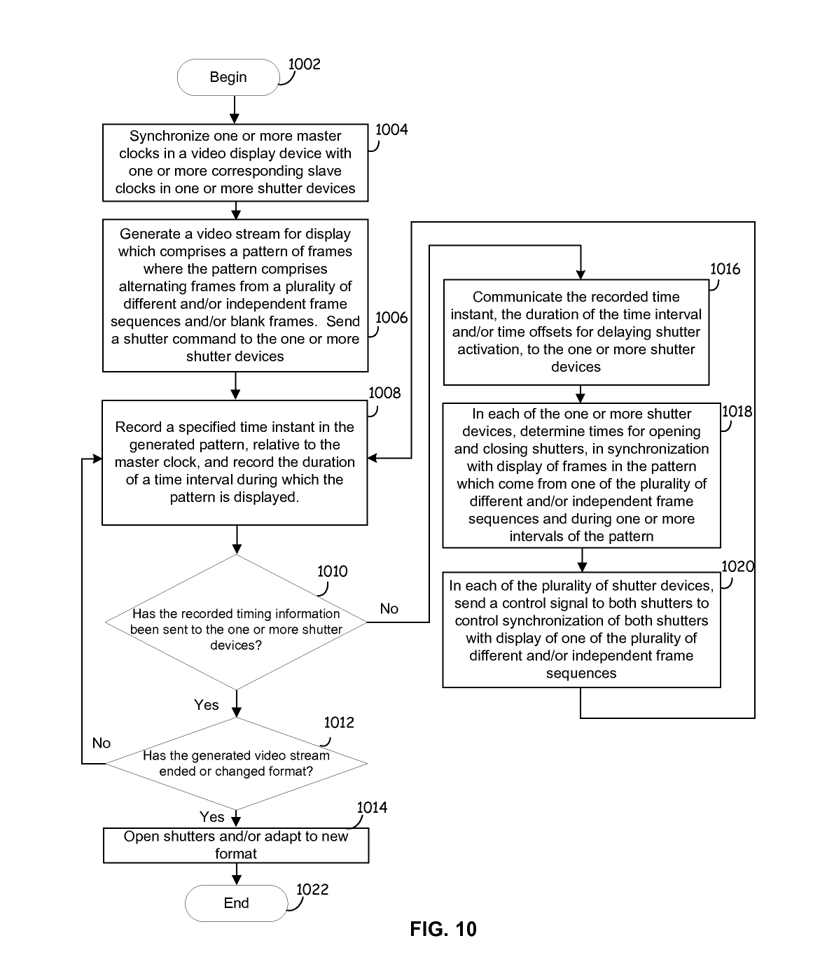

FIG. 10 is a flow chart illustrating exemplary steps for synchronizing each one of a plurality of shutter devices to display of a corresponding one of plurality of interleaved frame sequences, in accordance with an embodiment of the invention. Referring to FIG. 10, the exemplary steps may begin at step 1002. In step 1004, one or more master clocks, for example, the master clock 454 in the video display device 830 may be synchronized with one or more corresponding slave clocks, for example, the slave clocks 452A and 452B, in one or more shutter devices, for example, 800A and 800B. In step 1006, a video stream for display which may comprise a pattern of frames, for example, the frame sequence 750 or 752 may be generated, where the pattern may comprise alternating frames from a plurality of different and/or independent frame sequences and/or blank frames, for example, alternating frames from the frame sequences 700 and 702. A shutter command may be sent to the one or more shutter devices 800A and/or 800B by the video display device 830. In step 1008, a specified time instant in the generated pattern, relative to the master clock 454 may be recorded, and/or the duration of a time interval during which the pattern is displayed may be recorded. In step 1010, in instances when the recorded timing information has already been sent to the one or more shutter devices, the exemplary steps may proceed to step 1012. In step 1012, in instances when the generated video stream has ended or changed format, the exemplary steps may proceed to step 1014. In step 1014, the shutter devices 800A and/or 800B may adapt to a new format. For example, the video display device 830 may begin to display a single sequence of frames and the shutters 810A and 810B may remain open. The exemplary steps may end at step 1022.

In step 1010, in instances when the recorded timing information has not been sent to the one or more shutter devices 800A and/or 800B, the exemplary steps may proceed to step 1016. In step 1016, the recorded time instant, the duration of the time interval and/or time offsets for delaying shutter activation may be communicated to the one or more shutter devices 800A and/or 800B by the video display device 830. In step 1018, in each of the one or more shutter devices, for example, 800A and/or 800B, time instants may be determined for opening and closing respective shutters in the one or more shutter devices. The determined time instants of each shutter device, 800A and/or 800B may be synchronized with display of frames in the pattern which correspond to one of the plurality of different and/or independent frame sequences. The shutter open and/or close time instants may be determined for one or more intervals of the pattern. In step 1020, in each of the plurality of shutter devices 800A and/or 800B, a control signal may be sent to both shutters, for example, to the shutters 810A in the shutter device 800A and/or to the shutters 810B in the shutter device 800B, to control synchronization of both shutters in each shutter device with display of one of the plurality of different and/or independent frame sequences by the video display device 830.

In step 1012, in instances when the generated video stream has not ended or changed format, the exemplary steps may proceed to step 1014.

In an embodiment of the invention, a video viewing shutter device, for example the shutter device 800A and/or 800B that is wirelessly coupled to a multi-view video display device 830 may comprise a slave clock 452A and/or 452B respectively that may be generated based on a master clock 454 in the multi-view video display device 830. Synchronization of the slave clocks 452A and/or 452B with the master clock 454 may be maintained. The video viewing shutter device, for example, the shutter device 800A and/or 800B may receive information about display of one or more of a plurality of different and/or independent video frames, for example, the sequence A frame 822 and/or the sequence B frame 832 and time information that is referenced to the master clock 454, from the multi-view video display device 830. The time information may correspond to a time of the display of the one or more of the plurality of different and/or independent video frames, for example, the sequence A frame 822 and/or the sequence B frame 832. Both shutters 810A of the video viewing shutter device 800A, for example, may be opened and/or closed to correspond to a time of display of one of the plurality of different and/or independent video frames, for example, the sequence A frame 822. Furthermore, both shutters 810A may be opened and/or closed based on the generated slave clock 452A, the received information about the display of the one or more of the plurality of different and/or independent video frames, for example, the sequence A frame 822 and/or the sequence B frame 832 and/or the received time information that is referenced to the master clock 454.

The slave clock 452A and the master clock 454 may comprise a Bluetooth slave clock 452A and a Bluetooth master clock 454 respectively. The information about the display of the one or more of the plurality of different and/or independent video frames, sequence A frame 822 and/or the sequence B frame 832, may comprise information about a pattern of frames where the pattern of frames may comprise one or both of frames from the plurality of different and/or independent frame sequences, for example, the sequence A 700 and the sequence B 702 and blank frames, that are displayed on the multi-view video display device 830. The information about the display of the one or more of the plurality of different and/or independent video frames A frame 822 and/or B frame 832 may comprise a length of a time interval corresponding to displaying a pattern of frames, for example, a pattern in the sequence of frames 750 or 752 which may comprise one or both of the frames A frame 822 and/or B frame 832, from the plurality of different and/or independent frame sequences, the sequence A 700 and the sequence B 702 and blank frames that are displayed on the multi-view video display device 830.

The information about the display of the one or more of the plurality of different and/or independent video frames A frame 822 and/or B frame 832, may comprise a refresh rate for displaying frames from at least one of the plurality of different and/or independent frames sequences A 700 and B 702. The time information that is referenced to the master clock 454 may indicate master clock 454 time that may correspond to the display of the one or more of the plurality of different and/or independent video frames A frame 822 and/or B frame 832. The information about the display of the one or more of the plurality of different and/or independent video frames A frame 822 and/or B frame 832, may comprise a time offset for delaying opening and/or closing of both shutters 810A of the video viewing shutter device 800A and/or both shutters 810B of the video viewing device 800B. The shutters 810A and/or 810B may be opened and/or closed based on the generated slave clocks 452A and/or 452B respectively, the received information about the display of the one or more of the plurality of different and/or independent video frames and the received time information that is referenced to the master clock 454. A correspondence in time between time of opening and closing both shutters 810A and the time of the display of the one or more of the plurality of different and/or independent video frames may be maintained when new information about display of the one or more of the plurality of different and/or independent video frames and new time information that is referenced to the master clock 454, is not received and/or not utilized. Information may be transmitted to the multi-view video display device 830. In this manner, a shutter device 800A and/or 800B, for example, may be synchronized to a television refresh rate of the multi-view video display device 830.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for synchronizing shutter glasses to a display device refresh rate.

Accordingly, the present invention may be realized in hardware, software, or a combination of hardware and software. The present invention may be realized in a centralized fashion in at least one computer system or in a distributed fashion where different elements may be spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in a video viewing shutter device that is wirelessly coupled to a multi-view video display device:
generating a slave clock based on a master clock in said multi-view video display device;
maintaining synchronization of said slave clock with said master clock;
receiving from said multi-view video display device, information about display of one or more of a plurality of different and/or independent video frames and time information that is referenced to said master clock, wherein said time information corresponds to a time of said display of said one or more of said plurality of different and/or independent video frames; and
opening and closing both shutters of said video viewing shutter device to correspond to a time of display of one of said plurality of different and/or independent video frames, based on said generated slave clock, said received information about said display of said one or more of said plurality of different and/or independent video frames, and/or said received time information that is referenced to said master clock.

2. The method according to claim 1, wherein said slave clock and said master clock comprise a Bluetooth slave clock and a Bluetooth master clock respectively.

3. The method according to claim 1, wherein said information about said display of said one or more of said plurality of different and/or independent video frames, comprises information about a pattern of frames where said pattern of frames comprises one or both of:
frames from said plurality of different and/or independent frame sequences, which are displayed on said multi-view video display device; and
blank frames, which are displayed on said multi-view video display device.

4. The method according to claim 1, wherein said information about said display of said one or more of said plurality of different and/or independent video frames, comprises length of a time interval corresponding to displaying a pattern of frames which comprises one or both of:
frames from said plurality of different and/or independent frame sequences, which are displayed on said multi-view video display device; and
blank frames, which are displayed on said multi-view video display device.

5. The method according to claim 1, wherein said information about said display of said one or more of said plurality of different and/or independent video frames, comprises a refresh rate for displaying frames from at least one of said plurality of different and/or independent frames sequences that are displayed on said multi-view video display device.

6. The method according to claim 1, wherein said time information that is referenced to said master clock indicates master clock time that corresponds to said display of said one or more of said plurality of different and/or independent video frames.

7. The method according to claim 1, wherein said information about said display of said one or more of said plurality of different and/or independent video frames, comprises a time offset for delaying opening and/or closing of said both shutters.

8. The method according to claim 1, comprising opening and closing said both shutters based on said generated slave clock, said received information about said display of said one or more of said plurality of different and/or independent video frames and said received time information that is referenced to said master clock.

9. The method according to claim 1, comprising maintaining a correspondence in time between a time of opening and closing said both shutters and said time of said display of said one or more of said plurality of different and/or independent video frames, when new information about said display of said one or more of said plurality of different and/or independent video frames, and new time information that is referenced to said master clock, is not received and/or not utilized.

10. The method according to claim 1, comprising transmitting information to said multi-view video display device.

11. A system for communication, the system comprising:
one or more processors and/or circuits for use in a video viewing shutter device, said video viewing shutter device being wirelessly coupled to a multi-view video display device during operation, wherein said one or more processors and/or circuits are operable to:
generate a slave clock based on a master clock in said multi-view video display device;
maintain synchronization of said slave clock with said master clock;
receive from said multi-view video display device, information about display of one or more of a plurality of different and/or independent video frames and time information that is referenced to said master clock, wherein said time information corresponds to a time of said display of said one or more of said plurality of different and/or independent video frames; and
open and close both shutters of said video viewing shutter device to correspond to a time of display of one of said plurality of different and/or independent video frames, based on said generated slave clock, said received information about said display of said one or more of said plurality of different and/or independent video frames, and/or said received time information that is referenced to said master clock.

12. The system according to claim 11, wherein said slave clock and said master clock comprise a Bluetooth slave clock and a Bluetooth master clock respectively.

13. The system according to claim 11, wherein said information about said display of said one or more of said plurality of different and/or independent video frames, comprises information about a pattern of frames where said pattern of frames comprises one or both of:
frames from said plurality of different and/or independent frame sequences, which are displayed on said multi-view video display device; and
blank frames, which are displayed on said multi-view video display device; and
blank frames, which are displayed on said multi-view video display device.

14. The system according to claim 11, wherein said information about said display of said one or more of said plurality of different and/or independent video frames, comprises length of a time interval corresponding to displaying a pattern of frames which comprises one or both of:
frames from said plurality of different and/or independent frame sequences, which are displayed on said multi-view video display device; and
blank frames, which are displayed on said multi-view video display device.

15. The system according to claim 11, wherein said information about said display of said one or more of said plurality of different and/or independent video frames, comprises a refresh rate for displaying frames from at least one of said plurality of different and/or independent frames sequences that are displayed on said multi-view video display device.

16. The system according to claim 11, wherein said time information that is referenced to said master clock indicates master clock time that corresponds to said display of said one or more of said plurality of different and/or independent video frames.

17. The system according to claim 11, wherein said information about said display of said one or more of said plurality of different and/or independent video frames, comprises a time offset for delaying opening and/or closing of said both shutters.

18. The system according to claim 11, wherein said one or more processors and/or circuits are operable to open and close said both shutters based on said generated slave clock, said received information about said display of said one or more of said plurality of different and/or independent video frames and said received time information that is referenced to said master clock.

19. The system according to claim 11, wherein said one or more processors and/or circuits are operable to maintain a correspondence in time between a time of opening and closing said both shutters and said time of said display of said one or more of said plurality of different and/or independent video frames, when new information about said display of said one or more of said plurality of different and/or independent video frames, and new time information that is referenced to said master clock, is not received and/or not utilized.

20. The system according to claim 11, wherein said one or more processors and/or circuits are operable to transmit information to said multi-view video display device.
